(19) United States
(12) Patent Application Publication
(10) Pub. No.: US 2024/0152929 A1
(43) Pub. Date: May 9, 2024

(54) VALUE TRANSFER PROCESSING PLANS

(71) Applicant: Woje, Inc., Saratoga Springs, UT (US)

(72) Inventors: Scott Allan Johnson, Saratoga Springs, UT (US); Christian Tarjei Printz Gylseth, Spanish Fork, UT (US); Dnyaneshwar Shrikrishna Gangamwar, Pune (IN); Ajit Laxman Wadkar, Pune (IN)

(73) Assignee: Woje, Inc., Saratoga Springs, UT (US)

(21) Appl. No.: 18/412,745

(22) Filed: Jan. 15, 2024

Related U.S. Application Data
(63) Continuation of application No. PCT/US22/73703, filed on Jul. 13, 2022.

(30) Foreign Application Priority Data
Jul. 15, 2021 (IN) 202121031821

(51) Int. Cl. G06Q 20/40; G06Q 20/10

(52) U.S. Cl. CPC G06Q 20/405; G06Q 20/10

(57) ABSTRACT

In response to failure of an initial value transfer in a computer system, user input can be provided to choose between multiple alternative fallback options to change a value transfer processing plan. As another example, in response to failure of a single initial value transfer specified in a processing plan, a processing plan modification routine can include revising the processing plan to incorporate a fallback option allowed in processing plan rules in the computer system, where the fallback option can include multiple scheduled fallback value transfers that are each for amounts that are less than an amount of the initial value transfer. Additionally, a user interface control can be designed to receive user input to indicate selection of a value transfer option from a plurality of available value transfer options with different amounts of automation or interactivity for value transfers made according to the value transfer options. An interactive calculator can also be provided for calculating and entering values in processing plan rules for a value transfer processing plan.

### RELATED APPLICATIONS

The present application is a continuation of International PCT Application No. PCT/US22/73703, filed Jul. 13, 2022, and titled VALUE TRANSFER PROCESSING PLANS, which claims priority to Indian Provisional Patent Application No. 202121/031,821, filed Jul. 15, 2021, titled INTERACTIVE VALUE TRANSFER PROCESSING PLANS, all of which are incorporated herein by reference. If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

### BACKGROUND

Transfers of value amounts due to be transferred from a sender to a receiver have been performed manually, and in some instances tracking and performing such transfers have been performed using computer systems.

### SUMMARY

Whatever the advantages of previous tools and techniques, they have neither recognized the tools and techniques described and claimed herein, nor the advantages produced by such tools and techniques.

In one aspect, the tools and techniques can include maintaining a processing plan in a computer system according to one or more processing plan rules in the computer system, with the processing plan including parameters for one or more initial value transfers from a sender profile to a receiver profile, to transfer an initial overall value amount. One of the one or more initial value transfers can be initiated in the computer system using the processing plan, and receiving a processing failure notification in the computer system. The processing failure notification can indicate that the one of the one or more initial value transfers has failed. A user input request can be generated. The user input request can include an indication of a failure of the one of the one or more initial value transfers, and the user input request can further include a request for user input to choose between multiple alternative fallback options to change the processing plan. The alternative fallback options can be specified or allowed in the processing plan rules. Responsive to the receiving of the processing failure notification, the user input request can be sent to the receiver profile via the computer system. A computer-readable user input selection of a first fallback option of the alternative fallback options in the user input request can be received from the receiver profile. The first fallback option can include multiple scheduled fallback value transfers that are each for amounts that are less than an amount of the one of the one or more initial value transfers. The first fallback option can change the processing plan to transfer a fallback overall value amount that is greater than the initial overall value amount. The processing plan can be revised to incorporate the first fallback option. Additionally, user input confirmation from the receiving profile can be requested for initiation of each of the multiple scheduled fallback value transfers according to the processing plan. Each of the multiple scheduled fallback value transfers can be initiated in response to the user input confirmation. Alternatively, the scheduled fallback value transfers may be automatically performed, which may include initiating the scheduled fallback transfers without requesting or receiving user input confirmation for the transfers.

In another aspect of the tools and techniques, a processing plan can be maintained in a computer system according to one or more processing plan rules in the computer system. The processing plan can include parameters for only one initial value transfer from a sender profile to a receiver profile to transfer an initial overall value amount. The initial value transfer can be initiated in the computer system using the processing plan. It can be determined that the initial value transfer has failed. In response to determining that the initial value transfer has failed, a processing plan modification routine can be performed. The processing plan modification routine can include revising the processing plan to incorporate a fallback option specified or allowed in the processing plan rules. The fallback option can include multiple scheduled fallback value transfers that are each for amounts that are less than an amount of the initial value transfer. The fallback option can change the processing plan to transfer a fallback overall value amount that is greater than the initial overall value amount. Also, each of the multiple scheduled fallback value transfers can be initiated.

In yet another aspect of the tools and techniques, in a value transfer computer system, a user interface control can be presented. The user interface control can be designed to receive user input to indicate selection of a value transfer option from a plurality of available value transfer options, which can include a first value transfer option and a second value transfer option, and which may include more than two such options. The first value transfer option can include processing plan value transfers being performed automatically via the value transfer computer system without requiring user input. The second value transfer option can include requiring user input confirming the processing plan value transfers prior to the processing plan value transfers being performed. The user interface control can further include an indication of whether the first value transfer option or the second value transfer option is currently selected. User input directed at the user interface control can be received. The user input can indicate a selection of a selected value transfer option that is either the first value transfer option or the second value transfer option. In response to the receiving of the user input directed at the user interface control, the user interface control can be changed from a first display state to a second display state to indicate the selection of the selected value transfer option.

Other tools and techniques are also described below, such as an interactive calculator for calculating and entering values in a value transfer processing plan.

This Summary is provided to introduce a selection of concepts in a simplified form. The concepts are further described below in the Detailed Description, along with other concepts. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a value transfer processing system.

FIG. 3 is a schematic diagram of a receiver database.

FIG. 4 is an illustration of an example of a display screen that can be presented by a value transfer processing system.

FIG. 5 is an illustration of another example of a display screen that can be presented by a value transfer processing system.

FIG. 6 is an illustration of yet another example of a display screen that can be presented by a value transfer processing system.

FIG. 7 is an illustration of yet another example of a display screen that can be presented by a value transfer processing system.

FIG. 8 is an illustration of yet another example of a display screen that can be presented by a value transfer processing system.

FIG. 9 is an illustration of yet another example of a display screen that can be presented by a value transfer processing system.

FIG. 10 is an illustration of yet another example of a display screen that can be presented by a value transfer processing system.

FIG. 11 is an illustration of yet another example of a display screen that can be presented by a value transfer processing system.

FIG. 12 is an illustration of yet another example of a display screen that can be presented by a value transfer processing system.

FIG. 13 is an illustration of yet another example of a display screen that can be presented by a value transfer processing system.

FIG. 14 is an illustration of yet another example of a display screen that can be presented by a value transfer processing system.

FIG. 15 is an illustration of yet another example of a display screen that can be presented by a value transfer processing system.

FIG. 16 is an illustration of yet another example of a display screen that can be presented by a value transfer processing system.

FIG. 17 is an illustration of yet another example of a display screen that can be presented by a value transfer processing system.

FIG. 18 is an illustration of yet another example of a display screen that can be presented by a value transfer processing system.

FIG. 19 is an illustration of yet another example of a display screen that can be presented by a value transfer processing system.

FIG. 20 is an illustration of yet another example of a display screen that can be presented by a value transfer processing system.

FIG. 21 is an illustration of yet another example of a display screen that can be presented by a value transfer processing system.

FIG. 22 is an illustration of yet another example of a display screen that can be presented by a value transfer processing system.

FIG. 23 is an illustration of yet another example of a display screen that can be presented by a value transfer processing system.

FIG. 24 is a flowchart illustrating a value transfer processing plan technique.

FIG. 25 is another flowchart illustrating a value transfer processing plan technique.

FIG. 26 is yet another flowchart illustrating a value transfer processing plan technique.

### DETAILED DESCRIPTION

Aspects described herein are directed to techniques and tools for improved computerized value transfer processing, where processing is performed to transfer values from one computer system record associated with a sender user profile (a sender profile) to another computer system record associated with a receiver user profile (a receiver profile). Such improvements may result from the use of various techniques and tools separately or in combination.

Previously, plans have been utilized to transfer values from a sender user profile to a receiver user profile via a computer system at a set interval until an overall value amount has been transferred under a plan. Time-based rates have sometimes been added to the overall amount to be transferred. For example, in some instances, users have tracked amounts to be transferred and amounts added using time-based rates using computer-readable spreadsheet software that includes formulas in spreadsheet cells. Also, transfers via a computer system have often been manually initiated by the receivers or the senders. For example, in monetary transfers, this has included using printed checks whose values may have been scanned or manually entered into a computer system, or other manually initiated transfers, such as manually initiated credit card transfers. If such a transfer failed (such as a bounced check in a monetary transfer), a receiving user could update the spreadsheet to indicate different terms from that point forward, such as initiating lower periodic value transfer amounts and/or increasing time-based rates for increasing the overall amount to be transferred. Thus, as an example, an initial single transfer that did not involve interest payments could be converted into a financed scenario where multiple payments were made, and interest was charged. The present inventors have found that such computerized systems for transferring values according to plans have suffered from too much reliance on user input and other user actions, which have required significant time by users, been subject to significant user errors, and required significant additional computer resources due to the manual interactions with the computer systems.

In other situations, computer systems have used processing plans to automatically transfer values from the sender to the receiver in a computer system at a set interval until an overall value amount has been transferred under a processing plan. Time-based rates have been added to the overall amount to be transferred. Also, rules have dictated actions to be automatically taken if a transfer fails, such as trying to transfer a specified lower value amount to be automatically transferred and/or automatically increasing the time-based rate being applied under the plan. The present inventors have found that such fully automated processing of processing plans have created computer-centric problems of being automated to the extent that the computer systems have not allowed for sufficient interactions with the users in managing the processing plans. This can result in inability of the computer system to sufficiently receive and respond to user input indications of modifications to be made to the processing plans and the value transfers to be made using the processing plans. Thus, such over-automation of processing plans can result in a lack of ability of users to control the operation of the computer system in making value transfers using processing plans.

Techniques and tools discussed herein may include maintaining processing plans and initiating processing of value transfers according to the plans. A processing plan is a computer-readable plan for transferring values from a sender value record to a receiver value record, so that an amount in the sender value record is decreased by the amount of the transferred value and an amount in the receiver value record is increased by the amount of the transferred value. As an example, a value transfer may be a scheduled value transfer that is initiated after confirming user input is provided at or after a scheduled time (such as on a scheduled day or after that scheduled day). For example, a processing plan may indicate that a first manual value transfer has already been made outside the processing plan computer service, and that a second value transfer (a scheduled value transfer) is to be made at a scheduled time upon the computer system receiving confirmation that the second value transfer has not already been made outside the system. Processing plan rules may specify an overall principal value amount to be transferred for the processing plan, and may specify amounts that have been transferred outside the processing plan computer service. The processing plan may also include additional values that depend on events in the execution of the processing plan, such as additional amounts to be transferred as calculated from time-based rates that can be periodically applied by the computer system as time-based percentages of value amounts still to be transferred in the processing plan at specified times (e.g., 9% per year of value amounts still to be transferred, with the additional values calculated using the rate and added to the value amounts still to be transferred on a monthly, daily, or annual basis (i.e., interest amounts compounded monthly, daily, or annually)), and/or set penalty values for failed value transfers.

The processing plans may be interactively changed in response to user input, such as where such user input is retrieved in response to events in the computer system, and parameters for such changes can be set in computer-readable rules in the computer system. For example, the processing rules may include sender processing rules for the sender from which the value transfers are being made, as well as processing plan rules for each of the processing plans. For example, processing plan rules for a processing plan may include fallback options that specify alternative ways the processing plan can change in response to failure of a value transfer specified by the processing plan. The computer system can respond to a failed value transfer by triggering a user input request and sending the user input request to a receiver profile linked to the processing plan. The user input request can request user input to select one of multiple fallback options from the processing plan rules. In response to receiving such user input, the computer system can change the processing plan as specified in the received user input. For example, if a processing plan initially includes only one scheduled value transfer, but the one scheduled value transfer fails, then the fallback options can include multiple different options for a series of scheduled value transfers along with time-based rates of amounts due for increasing value amounts still to be transferred by the rate at specified times, and/or adding set penalty values to the value amount still to be transferred. The computer system can then execute the value transfers according to the processing plan, as changed by the selected fallback option. If one or more additional fallback triggering events occurs (e.g., another failed value transfer), then additional fallback options can be presented for selection by user input to make additional changes to the processing plan in this same manner.

The execution of scheduled value transfers according to a processing plan can include requesting user input confirmation for such value transfers at the scheduled times and making each value transfer in response to a user input confirmation being provided for that value transfer. This can provide additional interactivity with the system in addition to interactivity in making changes in processing plans.

As used herein, a user profile is a set of data that represents an entity such as a user, a group of users, a computing resource, etc. A user profile may include multiple sub-profiles. For example, a sender profile and a receiver profile are user profiles. A sender profile or receiver profile may be an individual user profile, or it may be a user profile for an organizational entity that also includes sub-profiles. For example, such an entity profile can include multiple user profiles that are sub-profiles representing individual users associated with the entity. The entity profile can be linked to the sub-profiles in the computer system so that the sub-profiles can access and manage data within the system that is accessible by the entity profile, and the sub-profiles can act on behalf of the entity profile. When references are made herein to a user profile performing actions (sending, receiving, etc.), those actions are considered to be performed by a user profile if they are performed by computer components in an environment where the user profile is active (such as where the user profile is logged into an environment and that environment controls the performance of the actions). Often such actions by or for a user profile are also performed by or for a user corresponding to the user profile. For example, this may be the case where a user profile is logged in and active in a computer application and/or a computing device that is performing actions for the user profile on behalf of a corresponding user. To provide some specific examples, this usage of terminology related to user profiles applies with references to a user profile providing user input, receiving responses, or otherwise interacting with computer components discussed herein.

A value transfer from a sender profile to a receiver profile can be performed by increasing an indication of a value amount of the transfer in a value record that is directly or indirectly referenced by the receiver profile, and by decreasing an indication of the value amount of the transfer in a value record that is directly or indirectly referenced by the sender profile. For example, the value records may be records of accounts that belong to the sender and receiver, respectively. Such a value transfer may include techniques to confirm and authenticate the transfer, and it may involve one or more intermediaries, such as a transfer gateway that can arrange for the transfer between one or more value tracking services that manage the computer-readable value records of the sender profile and/or receiver profile.

The system can also provide other tools and techniques to enhance the interactivity of the system, such as a calculator that can receive user input values (e.g., rates, value amounts, numbers of value transfers, amounts of time for scheduled value transfers) and use them to calculate others of such values (e.g., rates, value amounts, numbers of value transfers, amounts of time for scheduled value transfers). The system can also provide user input submission of values from the calculator to corresponding mapped fields for a processing plan.

Additionally, the system may provide a user interface control that can receive user input to indicate selection of a value transfer option from a plurality of available value transfer options. The value transfer options can include a first value transfer option and a second value transfer option. For example, the first value transfer option can include processing plan value transfers being performed automatically via the value transfer computer system without requiring user input. The second value transfer option can include requiring user input confirming the processing plan value transfers prior to the processing plan value transfers being performed. The user interface control can include an indication of whether the first value transfer option or the second value transfer option is currently selected.

In contrast with prior value transfer techniques that have either required large amounts of manual input or have severely limited interactive changes, the tools and techniques described herein can support interactivity in initiating value transfers and in making changes to value transfer processing plans. Such interactivity can provide users of the system with additional controls and functionality that are not present in previous systems. This can allow user input to initiate value transfers and changes to processing plans in more efficient and effective ways than has been done in previous systems.

Thus, the tools and techniques can provide added computer functionality, which provides computer-centric solutions to the computer-centric problems discussed above with prior approaches, such as providing users with automation in executing the value transfers dictated by the processing plans but also providing users with added interactive functionality in generating and modifying processing plans and/or controlling the operation of the computer system in managing and executing the value transfers according to the processing plans. Thus, the tools and techniques discussed herein can increase the efficiency and usability of the value transfer processing computer system.

Accordingly, one or more substantial benefits can be realized from the tools and techniques described herein. For example, a processing plan system can provide users with additional efficient user controls and tools to create and/or change processing plans, and to initiate value transfers specified in the plans. The system can also provide tools to track progress of the value transfer processing plans as events occur and are tracked in the computer system.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

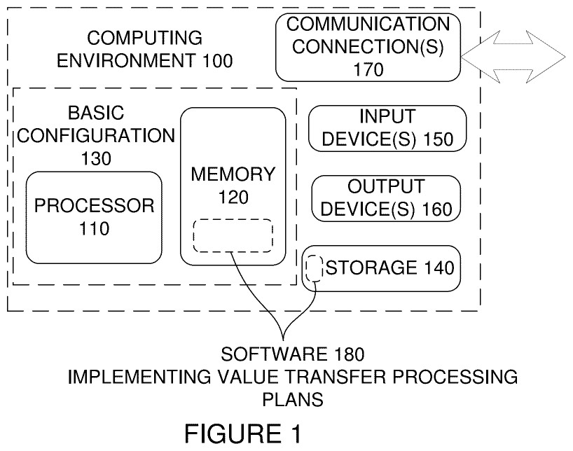

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment (100) in which one or more of the described aspects may be implemented. For example, one or more such computing environments can be used as a client device, a transfer gateway, a value tracking service, and/or a processing plan service. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing value transfer processing plans. An implementation of value transfer processing plans may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The memory (120) can include storage (140) (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information, and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device, or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level descriptions for operations performed by a computer and should not be confused with acts performed by a human being unless performance of an act by a human being (such as a “user”) is explicitly noted. The actual computer operations corresponding to these terms vary depending on the implementation.

### II. Value Transfer Processing System and Environment

A. Processing System Components

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

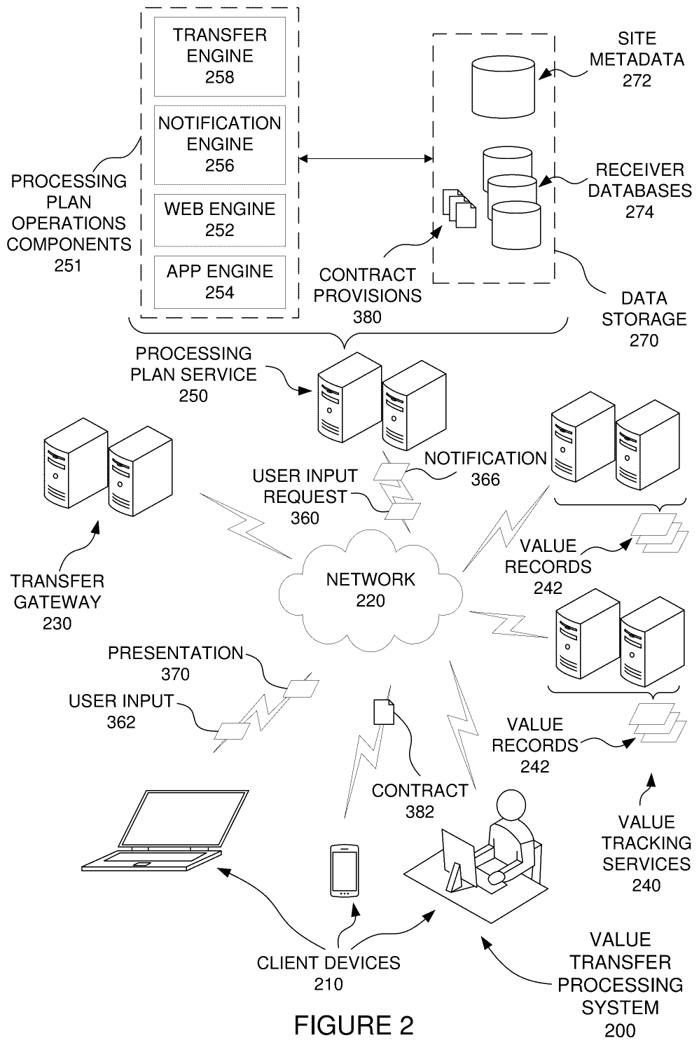

Referring now to FIG. 2, components of a value transfer processing system 200 will be discussed. Each of the components includes hardware and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various ways. For example, a single component may be distributed across multiple different computing machines (e.g., with some of the operations of the component being performed on one or more client computing devices and other operations of the component being performed on one or more machines of a server).

Referring still to FIG. 2, the value transfer processing system 200 can include client devices 210, such as laptop computers, desktop computers, and handheld computing devices. The client devices 210 can connect to other computing devices, such as those running the services discussed below, via a computer network 220, such as a global computer network, which may include multiple different types of sub-networks, including local area networks, wide area networks, and dedicated connections between networks and/or computing devices. The value transfer processing system 200 can also include a transfer gateway 230, which can also be connected to the network 220.

The transfer gateway 230 can act as a mediator to execute value transfers between different value tracking services 240 in the value transfer processing system, which can also be connected to the network 220. The value tracking services 240 can include value records 242, which can indicate value amounts associated with different users, entities and/or user profiles. For example, the value tracking services 240 may be computer systems operated by banks, and the value records 242 may be records of bank accounts that record amounts of currency. Similarly, the transfer gateway 230 may be configured to facilitate value transfers such as electronic funds transfers (wire transfers, clearinghouse transfers, etc.) between different value tracking services 240. However, the tools and techniques discussed herein could be used with other types of value transfers, such as transfers of cryptocurrencies, transfers of other types of value-indicating amount such as points in point systems, and so forth. In any event, a value transfer between different value records 242 can include electronic communications that execute an increase of a value amount in a receiving value record 242 and a corresponding decrease in a value amount in a sending value record 242, including sending transfer requests and transfer confirmations. The receiving and sending value records 242 in a value transfer may be maintained by the same value tracking service 240 or by different value tracking services 240. Accordingly, value transfers may be performed between different value records 242 within the same value tracking service 240 without using a transfer gateway 230. Value transfers may also be performed using electronic transmissions between different value tracking services 240 without using a value transfer gateway 230.

The value transfer processing system 200 can also include a processing plan service 250. The processing plan service 250, the value tracking services 240, and the transfer gateway 230 are all illustrated as being separate, but two or more of them could be included in a single service. For example, the processing plan service 250 could also perform the operations discussed herein as being provided by the transfer gateway 230 and/or the value tracking services 240.

Communications between the different services and/or client devices discussed herein, as well as communications and storage within the services and client devices can be done using techniques that help to inhibit attacks on the security and/or privacy of the communications and data discussed herein. For example, these may include encryption of data at rest and in transit, as well as authenticity confirmations, such as digital certificates and digital signatures. Additional techniques may also be employed to respect the privacy of users whose data is utilized in the system, such as opt-in and/or opt-out techniques, and disclosures of privacy policies.

B. Processing Plan Service Components

Referring still to FIG. 2, the processing plan service 250 can include processing plan operations components 251. The processing plan operations components 251 can include a web engine 252, which can interact with web browsers running on the client devices 210 via the network 220. For example, the web engine 252 can assemble webpages and send the webpages to the client devices 210, such as using network transfer protocols, such as Hypertext Transfer Protocol Secure (HTTPS) and/or other protocols. The webpages may utilize one or more languages, such as a markup language (e.g., hypertext markup languages) and/or one or more other languages (e.g., scripting languages such as JavaScript). The webpages may be pre-assembled and/or assembled dynamically. For example, the web engine 252 may utilize pre-existing templates, and may generate webpages by filling the templates with data dynamically in response to webpage requests from user profiles running on the client devices 210. Thus, the web engine 252 can provide page data to the client devices 210 in formats that are configured to be utilized by the web browsers, and to receive requests and responses from those web browsers. Accordingly, the web engine 252 can interact with user profiles that are active on the client devices 210.

The operations components 251 may also include an app engine 254, which can be configured to interact with client computer applications running on the client devices 210, with the client computer applications being specifically configured to interact with the processing plan service 250. For example, such applications may be mobile applications, such as mobile applications configured to run on the IOS or Android operating systems. The app engine 254 can provide page data to the client devices 210 in formats that are configured to be utilized by the corresponding applications, and to receive requests and responses from those applications. Accordingly, the web engine 252 can interact with user profiles that are active on the client devices 210 (such as where a logged-in communication session for a user profile from the processing plan service is active between a client device 210 and the processing plan service 250).

The operations components 251 can also include a transfer engine 258, which can manage the value transfers that have been initiated using the processing plan service 250. For example, the transfer engine 258 can request that the transfer gateway 230 make such transfers, and can receive status updates of the transfers from the transfer gateway 230 regarding the requested transfers. One or more transfer engines 258 can interact with one or more different transfer gateways 230 to initiate the value transfers discussed herein.

The operations components 251 can also include a notification engine 256. The notification engine 256 can trigger notifications to be sent to user profiles on the client devices 210 to notify the user profiles of status updates. The notifications may include user input requests, such as requests for user input to choose between different processing plan fallback options.

The processing plan service 250 can generate additional processing plan operations components 251 (transfer engines 258, notification engines 256, web engines 252, and/or app engines 254) as appropriate to scale up and down to handle different levels of loads on the system, such as from higher or lower numbers of user profiles on client devices 210 interacting with the processing plan service 250 at a given time.

The processing plan operations components 251 can retrieve and/or revise data in data storage 270 in the processing plan service 250. The data storage 270 can include site metadata 272, which can include overall data for the processing plan service 250. For example, the site metadata 272 may include one or more databases that include links (such as references) to receiver databases 274.

The receiver databases 274 can include a database for each receiver that is to receive value transfers using the processing plan service 250. While the data in the receiver databases may be combined into a single database or configured in some other way, having a dedicated database for each receiver can assist in inhibiting breeches of data integrity between the data of different receivers.

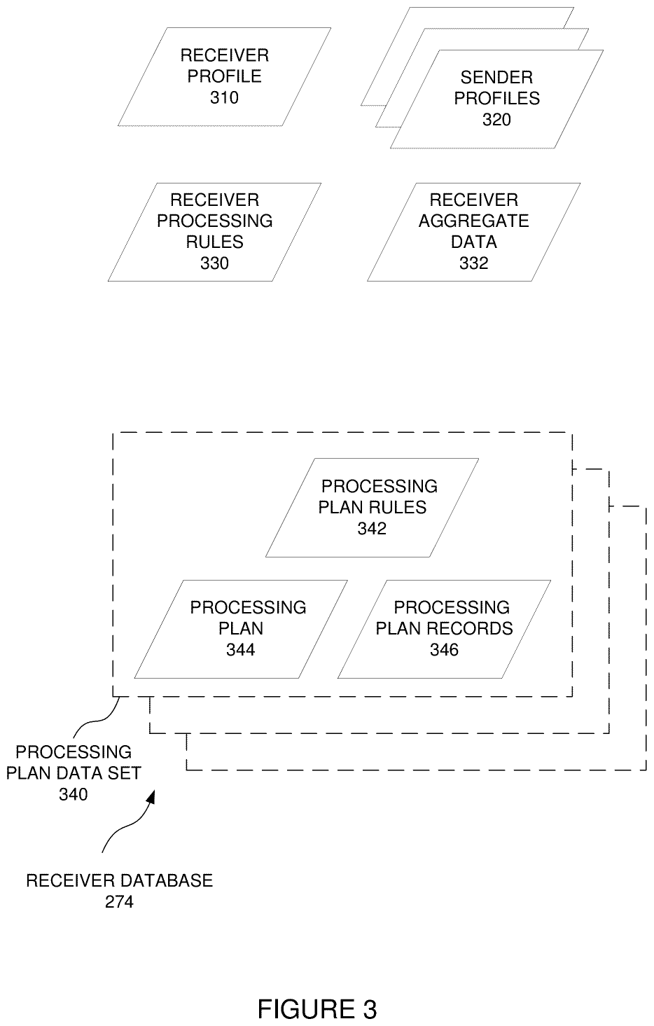

Each receiver database 274 can include multiple different types of database objects in one or more database formats that can include database tables, rows, columns, and records, for example. Referring to FIGS. 2 and 3, the data in a receiver database 274 can include a receiver profile 310, which can include data representing information such as name, contact information, bank account and bank routing numbers, username, and password for a receiver profile 310 that represents a receiver organization or individual. The processing plan service 250 can store such information and may also use the information in performing actions for the receiver profile 310, such as authenticating logins using the receiver profile 310 (e.g., using the username and password from the receiver profile 310), and requesting value transfers (e.g., using the name, routing numbers, and account numbers for the receiver profile 310).

A receiver database 274 can also include sender profiles 320 of senders who will send value transfers to the receiver. As with the receiver profile 310, the sender profiles 320 may include data representing information such as name, contact information, account and routing numbers used to identify and locate the sender and receiver value records 242, username, and password. The processing plan service 250 can store such information and may also use the information in performing actions for the sender profile 320, such as authenticating logins using the sender profile 320 (e.g., using the username and password from the sender profile 320), and requesting value transfers (e.g., using the name, routing numbers, and account numbers for the sender profile 320). A single sender profile 320 may be configured to send value transfers to multiple receiver profiles 310. Likewise, a single receiver profile 310 may be configured to receive value transfers from multiple sender profiles 320. Also, a receiver profile 310 may also be able to send value transfers, and a sender profile 320 may also be able to receiver value transfers. Thus, each such user profile may be considered both a sender profile and a receiver profile.

The receiver processing rules 330 can include computer-readable rules that include parameters for the processing plans to be generated and managed for a particular receiver associated with the receiver profile 310 and the receiver database 274. For example, the receiver processing rules 330 may include types of plan sections that can be included in the processing plans for the receiver profile 310 in that receiver database 274. For example, receiver processing rules may include parameters for the maximum and/or minimum amounts for the time-based rate charges (e.g., interest rate charges), maximum and/or minimum amounts for failed value transfer penalties, and/or limitations on ways the value transfers may be arranged (e.g., time limits or maximum numbers for periodic value transfers in a processing plan).

Each receiver database can also include receiver aggregate data 332, which can be data that represents aggregate sums from multiple different processing plans and multiple different sender profiles 320. For example, the aggregate data may represent an amount for the portions of all the value transfers received that were from transfers of principal amounts during a time period (e.g., a calendar year, a fiscal year, a month, or some other time period), an amount for the portions of all the value transfers received that were from transfers of time-based rate amounts and penalty amounts during a time period, and an amount of all the value transfers that were not received during a time period because of failed value transfers. Such aggregate amounts may be calculated by the processing plan service 250 in the background and stored in the receiver aggregate data 332 in the corresponding receiver database 274. Aggregate amounts may also be dynamically calculated by the processing plan service 250 in response to individual requests for aggregate data for a receiver profile 310.

The same types of aggregate data may be calculated maintained by the processing plan service 250 for sender profiles 320. Upon logging in to the processing plan service 250 (and possibly in response to requests after logging in), a sender profile 320 may be provided with representations of such aggregate data, including aggregate data from processing plans 344 in multiple receiver databases 274 if the sender profile 320 has processing plans 344 with multiple receiver profiles 310. Additionally, such representations of aggregate data (such as numbers and/or charts) may be sent to the sender profile 320 for presentation to the sender profile 320, and the presentations of aggregate data may be filtered in ways like filtering for the receiver profiles 310 (e.g., filtering based on time, based on identity of one or more receiver profiles 310 when filtering for sender profiles 320, based on types of value earnings (such as from principal, from interest or fees, or all of these)).

The receiver database 274 can also include processing plan data sets 340. Each processing plan data set 340 can include processing plan rules 342, a processing plan 344, and processing plan records 346. A processing plan 344 is a set of data that indicates amounts and circumstances under which value transfers are planned to be made. For example, a processing plan 344 may include data indicating that an initial value transfer will be made using the processing plan service 250 on a specified date if the value transfer is not made in some other way prior to that time. The processing plan service 250 may send a receiver profile 310 a notice on that specified date, and request user input to confirm that the value transfer is to be made by the processing plan service 250. A processing plan 344 may also indicate amounts and times for current and future value transfers under the processing plan 344, and other data such as an overall value amount to be transferred under the processing plan 344, and possibly an indication of related amounts that have already been transferred outside the processing plan service 250.

A processing plan data set 340 can also include processing plan rules 342, which can govern the processing plan 344, including dictating what fallback options are allowable for the processing plan 344. Thus, fallback options or changes to the processing plan 344 can be required to comply with the processing plan rules 342 that apply to that processing plan 344 and with the more general receiver processing rules 330, which can apply to all processing plans 344 for that receiver and consequently for the corresponding receiver profile 310. For example, processing plan rules 342 may specify maximum, minimum, and/or default value amounts for failed value transfer penalties for that processing plan 344. Processing plan rules 342 may also specify maximum, minimum, and/or default time-based rates such as interest rates that may be applied to value amounts to be transferred under the processing plan 344. Processing plan rules 342 may also specify other items, such as minimum value amounts that can be transferred in each periodic value transfer under the processing plan 344. The processing plan rules 342 can be agreed to by the sender and receiver prior to using the processing plan 344 in the processing plan service 250. However, processing plan rules 342 may be changed in the processing plan data set 340 even after value transfers have begun to be processed using the processing plan 344, so long as such changes comply with the receiver processing rules 330. For example, such changes may be agreed to by a sender profile 320 and a receiver profile 310 by providing user input to the processing plan service 250, with the user input confirming the changes.

A processing plan data set 340 can also include processing plan records 346. The processing plan records 346 can include records of previous events related to the processing plan 344, including dates of such events. For example, such events may include previous balances of amounts due, amounts transferred in previous value transfer events, how much of such transferred value amounts were for principal values that were initially due and how much of such value transfers were for time-based rate additions (such as interest) and penalties. The processing plan records 346 may be represented in data structures such as a ledger table, which may also include the future dates and amounts for the transfers still to be made according to the processing plan 344.

C. Value Transfer Processing System Operation

Referring to FIGS. 2-3, the value transfer processing system 200 can operate to generate processing plans 344, manage processing plans 344, use the processing plans 344 to process value transfers in the value transfer processing system 200, and track and generate representations of past events for the processing plans 344.

1. Processing Plan Generation

The value transfer processing system 200 can operate to generate processing plans 344 and related computer-readable data items, such as those in the receiver databases 274.

As an example, the processing plan service can generate and send user input requests to a client device 210 for user input 362 to generate a receiver profile 310. As an example, the web engine 252 may provide a new receiving user of the processing plan service with a user input request 360 such as a webpage that prompts a client device 210 for user input 362 to generate a receiver profile 310. Alternatively, the app engine 254 may send user input requests in the form of page data to prompt an application running on a client device 210 to display a page that prompts the client device for user input 362. Similarly, with the pages and responsive user input discussed elsewhere herein, such interactions may be handled by a web engine 252 or an app engine 254, or some other type of engine for sending data to be displayed on a client device 210 and receiving and processing responsive user input 362.

For example, the user input 362 for generating a user profile may include verification information, such as a username and a password. One or more user input requests 360 from the processing plan service 250 may also prompt additional user input 362 to be provided, representing additional information for the receiver profile, such as a corresponding receiver's name (e.g., a company name or individual's name), contact information (e.g., a receiver's physical address, a receiver's email address, a receiver's telephone number), a receiver's data for its value records 242 with a value tracking service 240 (such as bank name, name on a receiver's bank account, bank address, bank routing number, and receiver's bank account number with a bank). The processing plan service 250 can respond to user input from the receiver profile 310 by generating a receiver database 274 for the new receiver profile 310 and storing the profile data from the received user input 362 as a receiver profile 310 in the new receiver database 274.

The processing plan service 250 can also prompt a client device 210 for user input 362 to generate a sender profile 320. For example, the user input 362 may include verification information, such as a username and a password. One or more user input requests 360 from the processing plan service 250 may also prompt additional user input 362 to be provided, representing additional information for the sender profile, such as a sender's name (e.g., a company name or individual's name), contact information (e.g., a sender's physical address, a sender's email address, a sender's telephone number), a sender's data for its value records 242 with a value tracking service 240 (such as bank name, name on a sender's bank account, bank address, bank routing number, and sender's bank account number with a bank). The processing plan service 250 can store the profile data from the received user input 362 as a sender profile 320 in the receiver database 274 for the sender that will receive value transfers from the sender profile 320. The data storage 270 may also link a sender profile 320 with additional receiver databases 274 if the sender profile 320 is configured to send value transfers to more than one receiver being tracked with more than one receiver database 274 using the processing plan service 250.

Some or all of the data for a sender profile 320 can be entered by user input from a receiver profile 310. For example, user input from a receiver profile 310 can provide data such as contact information, name, and bank information for a sender profile 320. User input from a receiver profile 310 may also initiate a bank account verification process for the bank information for a sender profile 320. For example, such a verification process (which may also be performed for receiver profile bank information) can include making a micro deposit into a bank account for the sender profile 310 using the entered information, and then requiring an amount of the micro deposit to be entered into the value transfer processing system 200 as user input. The value transfer processing system 200 can then verify the bank account information if the amount of the micro deposit that was made by the value transfer processing system 200 matches the amount entered by user input. If a receiver profile 310 provides user input with a sender profile's bank information (e.g., name on a bank account, routing number, and account number), then the corresponding receiver profile user can make a telephone call (or other communication method considered to be sufficiently secure) to the user corresponding to the sender profile 320 to request the amount of the micro deposit. The receiver profile user can then provide the amount of the micro deposit through user input through the receiver profile 310 at a client device 210 of the value transfer processing system 200.

The processing plan service 250 can generate user input requests 360 to request user input 362 to provide information to be included in the receiver processing rules 330 in the receiver database 274. For example, the user input 362 may indicate maximum and/or minimum time-based rates (e.g., interest rates), maximum and/or minimum penalties for value transfer failures, overall length of time or number of periodic value transfers allowed for a processing plan, and/or other parameters that can govern all the processing plans 344 in the receiver database 274 for that receiver profile 310. In response to receiving user input 362 defining the receiver processing rules 330, the processing plan service 250 can generate the receiver processing rules 330 and store the receiver processing rules 330 in the corresponding receiver database 274.

The user input requests and/or providing of user input for value amounts may be aided with the use of a calculator tool that can use displays in one or more webpages and/or dedicated application pages. For example, the calculator tool can include fields where some values can be entered by user input 362 for a processing plan 344, and the value transfer processing system 200 can calculate other values for the processing plan 344 from those values. Different values can be entered by user input and calculated by the value transfer processing system 200 using the calculator to see different entered and calculated values until satisfactory values are determined. User input can then be provided to request that the values currently displayed in the calculator be entered as user input values for a processing plan 344 being initially generated or a processing plan 344 that is being changed. The value transfer processing system 200 can then enter the values displayed in the calculator page into corresponding fields in processing plan rules 342 and processing plans 344. For example, the processing plan service 250 may maintain a computer-readable mapping of which fields in a calculator page correspond to which fields in processing plan rules 342 and processing plans 344. That mapping can be used by the processing plan service 250 to copy the values from the calculator page fields to the correct fields in the processing plan rules 342 and processing plans 344.

For example, user input 362 may enter an initial principal amount due to be transferred, a time-based rate such as an interest rate, and a number of monthly value transfers (i.e., how many monthly value transfers), and additional user input 362 can request that the calculator tool calculate the amounts of the monthly value transfers to cover the principal and accrued interest amounts. As another example, in that same calculator tool, user input 362 may enter an initial principal amount due to be transferred, a time-based rate such as an interest rate, and an amount for each monthly value transfer, and additional user input 362 can request that the calculator tool calculate the number of the monthly value transfers (i.e., how many monthly value transfers are needed to cover the principal and accrued interest amounts). The same calculator tool can perform calculations for these and other combinations of user input values and calculated values.

The processing plan service 250 can generate user input requests 360 to request user input 362 to provide information to be included in the processing plan rules 342 for a processing plan 344. For example, one or more user input requests 360 may request a total value amount to be transferred in relation to the processing plan, a value amount that is to be transferred as part of the processing plan 344 (which may be specified by indicating a value amount that has already been transferred outside of the processing plan service 250), a value amount and date for value transfers under the processing plan 344, and parameters defining fallback options (such as defining defaults and/or limits for fallback value transfer amounts, frequency, and/or numbers of fallback value transfers) if one or more of the scheduled value transfers in the processing plan 344 fails.

The user input requests 360 that request user input 362 to provide information to be included in the processing plan rules 342 can include user input requests 360 that indicate pre-existing digital contract provisions 380 stored in the data storage 270. The contract provisions can be included in a natural language textual digital contract 382 to be agreed upon between the sender profile 320 and the receiver profile 310. In response to user input 362 from the receiver profile 310 selecting contract provisions 380, the processing plan service 250 can generate the contract 382, which can include assembling the contract 382 with the selected contract provisions 380. The processing plan service 250 can send user input requests 360 to the receiver profile 310 and the sender profile 320, requesting confirmation of the contract, such as requesting digital signatures of the contract 382 from the receiver profile 310 and the sender profile 320. The processing plan service 250 can also use the user input 362 that selected the contract provisions 380 to generate the processing plan rules 342 for the processing plan 344. Thus, the processing plan service 250 can generate the processing plan rules 342 and the contract 382 using (and in response to) the user input 362 selecting the contract provisions 380.

Using data in the processing plan rules 342, the processing plan service 250 can define the processing plan 344. For example, the processing plan 344 may be in the form of a table that includes scheduled value transfers and dates for those scheduled value transfers. The table may also include amounts still to be transferred at the time of each of the scheduled value transfers, assuming value transfers are made according to the schedule. Accordingly, the processing plan service 250 can respond to user input by generating and populating the table for the processing plan 344. However, processing plans may be implemented in some other type of data structure besides a table, such as a markup language document.

2. Value Transfer Processing with Processing Plans

For a particular value transfer to be made using the processing plan 344, the processing plan 344 can indicate a value to be transferred and a date for the transfer to be made. The processing plan data set 340 can also indicate which sender profile 320 is to be the sender for the value transfers in the processing plan 344 (i.e., that sender profile's data will be used to transfer the value from a value record 242 represented in the data for that sender profile). Also, some of the sender's data and/or some of the receiver's data (e.g., bank account and routing number data) may be stored and maintained in a transfer gateway 230, which can facilitate the value transfer.

On the date indicated in the processing plan 344, the notification engine 256 can trigger a notification that the value transfer is to be made on that date. That notification can be sent to a receiver profile in a user input request 360, which can request user input 362 to confirm that the value transfer is to be made using the processing plan service 250. Accordingly, if the value transfer had already been made in some other way outside the processing plan service, then the user input 362 can request that the scheduled value transfer be cancelled instead of the user input 362 confirming the scheduled value transfer. Additional user input 362 can be provided to indicate a value amount (if any) that was transferred outside the processing plan service.

If the user input 362 confirms that the value transfer is to be made, then the web engine 252 or app engine 254 can send a request to the transfer engine 258 (such as in a function call or an application programming interface call) to initiate the value transfer. Such as request can alternatively be sent to the transfer engine 258 from a notification or scheduling engine without requesting user input if a setting indicates that the value transfer is to be made automatically without confirming user input. Either way, this initiation of the value transfer can include the transfer engine 258 interfacing with the transfer gateway 230 to request the transfer. This can include the transfer engine 258 sending data to the transfer gateway 230 to identify a value record 242 for the sender profile 320 and the receiver profile 310 for the processing plan 344. The transfer engine 258 can retrieve such data from the receiver database 274. The transfer gateway 230 may also store data to identify the value records 242. The transfer gateway 230 can interface with one or more value tracking services 240 to verify that a sufficient value amount is indicated in the value record 242 for the sender profile 320 (i.e., an amount equal to or greater than the value amount to be transferred, as indicated in the processing plan 344 and communicated to the transfer gateway 230). If the value tracking service 240 that hosts the value record 242 of the sender profile 320 finds that a sufficient value amount is present, then the transfer gateway 230 can act as an intermediary between the value tracking services 240 to add the value amount of the transfer to the receiver profile's value record 242 and to subtract the value amount of the transfer from the sender profile's value record 242.

If the transfer was successful (or possibly even if the transfer gateway 230 receives confirmation from the value tracking services 240 that sufficient value amounts are present and that the transfer will be made), then the transfer gateway 230 can send a confirmation to the transfer engine 258 in the processing plan service 250.

3. Processing Plan Management

In response to the confirmation that a value transfer was successful, the processing plan service 250 can then update the receiver database to indicate that the transfer has been made. Accordingly, data for the transfer can be removed from the processing plan 344 and included in the processing plan records 346 as an indication of an event that has already occurred. For example, this can include indicating in a table or other data structure that includes the processing plan that a scheduled value transfer has been made and a date when the scheduled value transfer was made. Additional information may also be included, such as a confirmation number for the value transfer. In response to a transfer being made, the notification engine 256 can optionally trigger a notification of the value transfer being made. That notification can be sent to the receiver profile 310 and/or the sender profile 320 as one or more notifications 366, which may or may not include a user input request 360.

If the transfer gateway 230 indicates that the transfer failed, such as if there was an insufficient amount of value indicated in the sender's value record 242, then the transfer gateway 230 can send a notification 366 of the failure to the transfer engine 258 of the processing plan service 250. The processing plan service 250 can respond by updating the processing plan 344 to remove the scheduled value transfer and to include an indication of the transfer failure in the processing plan records 346. The transfer engine 258 can notify the notification engine 256 of the failure (which may be done by the transfer engine 258 directly making a call to the notification engine 256 or in some other manner, such as by the transfer engine 258 updating the processing plan records 346 and the notification engine monitoring the processing plan records 346 for changes that will trigger notifications), and the notification engine 256 can generate a failure notification for the value transfer.

The failure notification can be sent as a notification 366 to the sender profile 320. Additionally, the failure notification can be sent to the receiver profile 310 as a notification 366 that is part of a user input request 360, requesting the receiver profile 310 to select a fallback option in response to the user input request 360. The receiver profile 310 may not immediately respond to the user input request 360. For example, a user associated with the receiver profile 310 may contact a user associated with the sender profile 320 to inquire about the sender's situation and to determine the best fallback position for the situation. The receiver profile 310 can provide user input 362 selecting one of multiple possible fallback options that are allowed under the receiver processing rules 330 and the processing plan rules 342. For example, the fallback options may include adding a series of periodic value transfers to the processing plan 344 with time-based rate increases (e.g., interest) in place of the single failed value transfer. Such a fallback option may also include immediately retrying the failed transfer at the same amount, or at a lower fallback amount. Also, a failure penalty amount may be added to an amount to be transferred under the processing plan 344. A transfer for that penalty amount may be attempted immediately, or the penalty amount may be added to one or more later value transfers. Moreover, if a time-based rate is already being added to value amounts to be transferred under the processing plan 344, then the rate may be increased in response to the failed transfer as part of a fallback option. Whatever fallback option is selected by the user input 362 from the receiver profile 310, the processing plan service 250 can respond to the selection in the user input 362 by making the requested changes in the processing plan 344 in the receiver database 274.

Additionally, one fallback option may include immediately retrying a value transfer with the same value amount as the failed value transfer, or a smaller amount, which can be specified in the selection in the user input 362 (possibly along with other changes to the processing plan 344, such as adding or increasing time-based rate additions to the value amounts to be transferred). If such a fallback option is selected, the processing plan service 250 can respond by retrying the value transfer with the specified value amount, such as in the manner discussed above. If this retry fails, then the processing plan service 250 can respond to the failure in the same way as the response to the initial failure, as discussed above. This can result in user input 362 selecting a different fallback option than was selected in response to the notification of the initial value transfer failure. On the other hand, if the retry succeeds, then the processing plan service can indicate the successful value transfer in the processing plan records 346, as discussed above.

In addition to making changes to a processing plan 344 in response to failures of value transfers, user input 362 may be sent from a receiver profile 310 at other times to request that changes be made to the processing plan 344. For example, a receiver profile 310 may request an edit page from the processing plan service 250, which can allow the user profile to enter processing plan changes on the edit page and submit those changes as user input 362, requesting changes to the processing plan 344. The processing plan service 250 can then make those changes in the processing plan 344 in the corresponding receiver database 274. For example, the processing plan service 250 may make changes to entries for planned value transfers in a table for the processing plan 344, which can be stored in the processing plan data set 340 in the receiver database 274.

4. Processing Plan Records and Aggregate Displays

As discussed above, the processing plan service 250 can maintain processing plan records 346 in the receiver database 274. For example, the processing plan records 346 may be maintained in a table that also includes entries for planned value transfers in the corresponding processing plan 344. As discussed above, the processing plan records 346 can include records of past events in the processing plan 344, such as past balances of values to be transferred under the processing plan 344, past successful value transfers under the processing plan 344, and past failures of value transfers under the processing plan 344, as well as records of changes to the processing plan 344 (e.g., changes in scheduled amounts of values to be transferred, changes in time-based rates to be added to amounts still to be transferred under the processing plan 344, and other past events that apply to the processing plan 344).

The processing plan service 250 can aggregate amounts from historic events under a single processing plan 344, and under multiple processing plans 344 for a single receiver profile 310 and/or for a single sender profile 320. This aggregating may be done using some filtering techniques, such as filtering for events during a specified period of time, filtering for events applying to one or more specified processing plans, filtering for events for one or more specified sender profiles 320, and/or filtering for events for one or more receiver profiles 310. The processing plan service 250 can perform calculations for this aggregating in the background prior to user input 362 requesting presentations of the receiver aggregate data 332, and/or dynamically in response to user input 362 requesting presentations of the receiver aggregate data 332.

Accordingly, in response to user input 362 from a receiver profile 310 requesting a presentation of receiver aggregate data 332, the processing plan service 250 can retrieve already calculated receiver aggregate data 332 and/or dynamically calculate the requested receiver aggregate data 332. The processing plan service 250 can then include the receiver aggregate data 332 in a presentation 370 (e.g., in a webpage using the web engine 252 and/or in page data for a dedicated application using the app engine 254) and can send that presentation to the receiver profile 310 on a client device 210, where the requested aggregate data can be presented, such as by using a visual display on a display screen and/or an audible presentation using a speaker.

Likewise, in response to user input 362 from a sender profile 320 requesting a presentation of sender aggregate data, the processing plan service 250 can retrieve already calculated sender aggregate data and/or dynamically calculate the requested sender aggregate data. The processing plan service 250 can then include the sender aggregate data in a presentation 370 (e.g., in a webpage using the web engine 252 and/or in page data for a dedicated application using the app engine 254) and can send that presentation to the sender profile 320 on a client device 210, where the requested aggregate data can be presented, such as by using a visual display on a display screen and/or an audible presentation using a speaker.

D. User Interface Display Examples

Some user interface display examples that can be used with the tools and techniques are discussed below. For example, each page may include one or more notifications 366, user input requests 360, and/or presentations 370. The examples may be implemented as different types of displays and sent in different formats. For example, the displays may be generated, sent to the client devices 210, and displayed as webpages. As another example, the displays may be generated, sent to the client devices 210, and displayed as dedicated application pages. In alternative implementations, similar presentations may be made using other formats that may include non-visual formats, such as audibly using computerized speech-to-text and text-to-speech techniques.

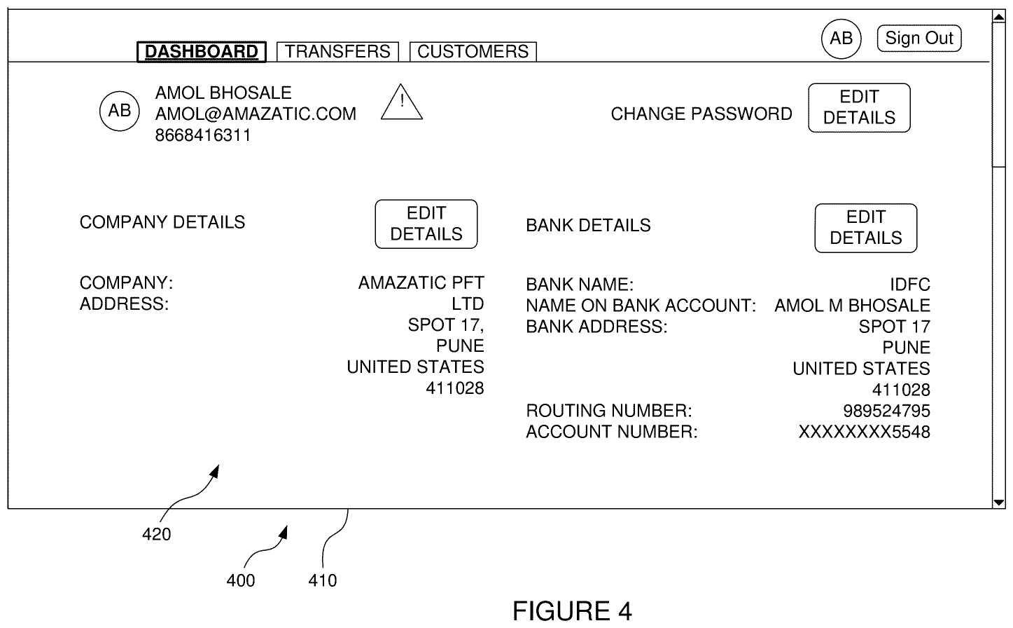

Referring now to FIG. 4, a display screen 400 is illustrated. The display screen 400 includes an example of a receiver profile page 410, which can include profile data 420 related to a receiver that is represented by a receiver profile 310. For example, the profile data may include an individual's name as well as a company name if the receiver is a company or other organization. The profile data 420 may also include contact information, such as an email address, a telephone number, and a physical address. The profile data 420 may also include a username and a password, though the password may not be displayed on the display screen 400. Additionally, the profile data 420 can include bank details, which can include details that can be used to identify the receiver profile's value tracking service 240 and value record 242, such as a bank account. User input can be provided to change the profile data 420. For example, user input may select “EDIT DETAILS” buttons to allow editing of the corresponding profile data, such as the company details, bank details, and password. Such editing may be performed by revising data in text boxes and submitting the resulting data as user input 362, which can be sent to the processing plan service 250 to update that data in the corresponding receiver database 274.

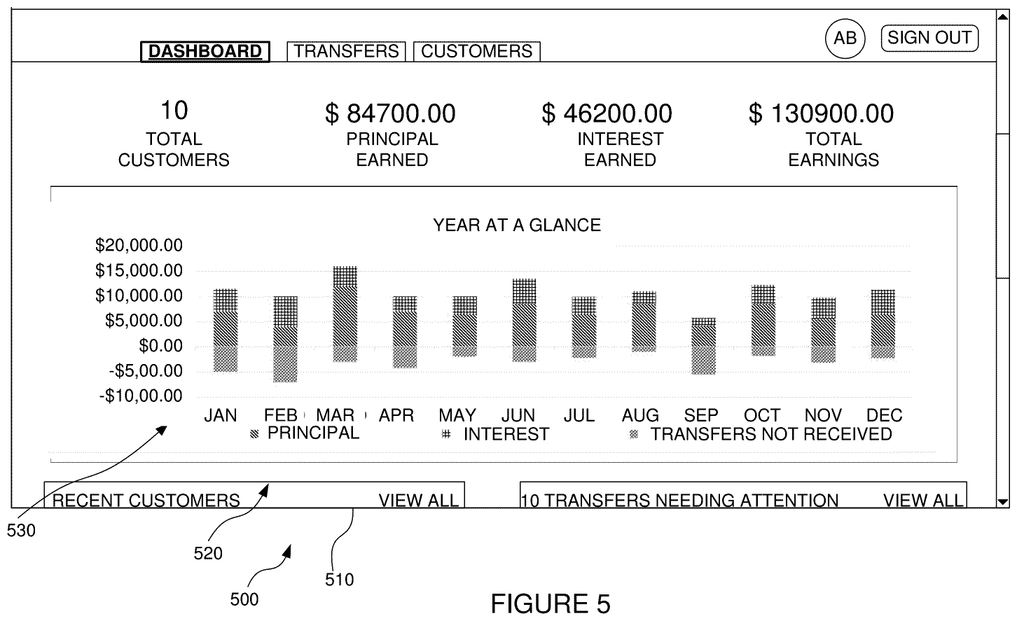

Referring to FIG. 5, a display screen 500 is illustrated, including a display of a first portion of a dashboard page 510. The dashboard page 510 can include a value transfer summary 520, which can summarize aggregate data for a period of time for the receiver profile 310. For example, the value transfer summary 520 can include one or more visual representations of aggregate data such numerical data (e.g., in one or more tables) or one or more graphical representations such as a bar chart 530, which may include a segmented bar for each month in a calendar year, or some other type of chart (e.g., one or more line charts, pie charts, area charts, or combinations of different types of charts). Each bar in the example bar chart 530 can include a segment representing principal earned (i.e., successful transfers of principal amounts), interest earned (i.e., successful transfers of interest amounts due to time-based rate additions to amounts to be transferred), and transfers that were scheduled during the time period but were not received (such as failed value transfers due to one or more factors such as insufficient value available to be transferred). The value transfer summary can also list the total number of sender profiles 320 that transferred value to the receiver profile 310 during the time period, the total amount of principal earned, the total amount of interest earned (which may also include penalty fees for failed value transfers, in addition to interest or time-based rate additions to amounts to be transferred), and the overall total amount earned during the calendar year.

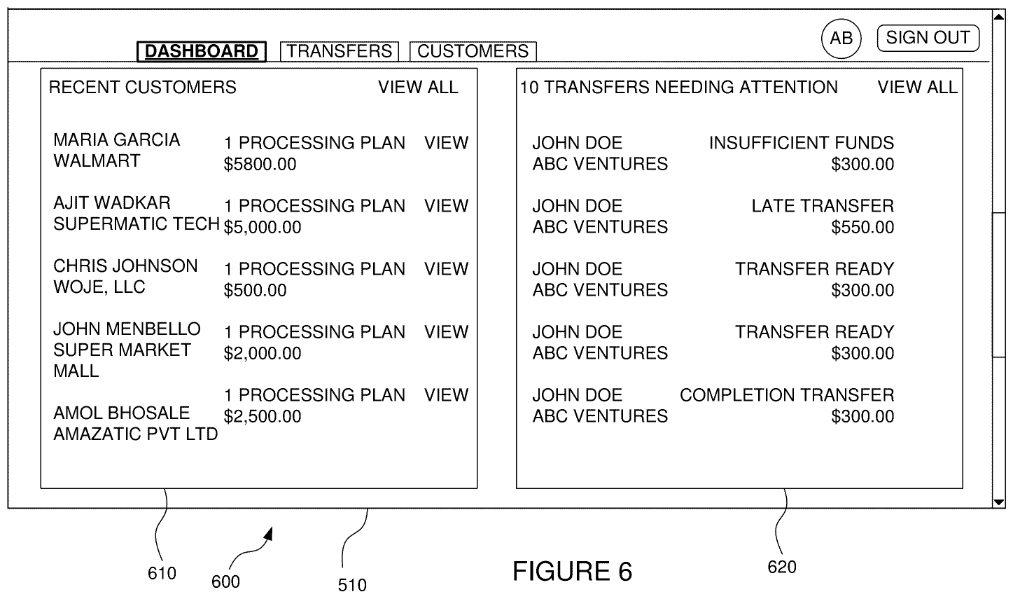

Referring now to FIG. 6, a display screen 600 is illustrated, including a second portion of the dashboard page 510. The second portion can include a recent customers list 610, which can list recent sender profiles 320 (with senders being called “CUSTOMERS” in the examples of the display screens), as well as the numbers of processing plans 344 in the receiver database 274 for each sender profile 320 and the total amount to be transferred under the processing plans 344.

The second portion of the dashboard page 510 illustrated in the display screen 600 can also include a notification list 620 (indicating “TRANSFERS NEEDING ATTENTION”). The notification list 620 can list notifications for value transfers for which user input is requested. For example, these can include value transfers that have failed, value transfers that are scheduled to occur and are merely awaiting user input confirmation before initiating the transfers, and possibly other notifications such as notifications of completed value transfers whose details are to be presented for review.

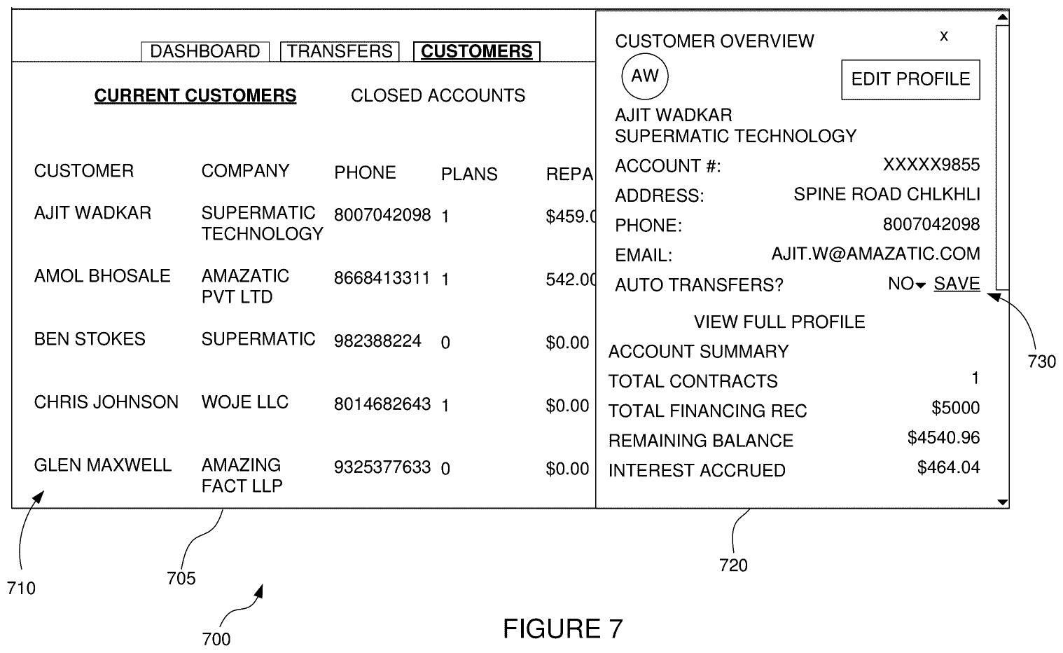

From the dashboard page 510, user input may be provided to select a “CUSTOMERS” tab 650. Selection of the “CUSTOMERS” tab can result in display of a display screen 700 (see FIG. 7) that includes a customer page 705, which can include a senders list 710, with information about sender profiles 320. Selecting one of the displayed names of a sender profile 320 in the senders list 710 can prompt the computer system to display a customer overview dialog 720, which can provide additional details about a sender profile 320. Additionally, the customer overview dialog 720 can include an edit profile button, which can be selected to edit the sender profile 320 like the way edits can be made to the receiver profile 310, as discussed above.

Moreover, at least some data for the sender profile 320 may be edited by the receiver profile 310 on the overview dialog 720. For example, the overview dialog 720 may include a display whether automatic transfers are to be made for the sender profile 320 without seeking user input confirmation from the receiver profile for each transfer. As an example, the overview dialog 720 may include an auto transfer user interface control 730, which can include the question “AUTO TRANSFERS?”, asking whether automatic transfers are to be made for the user profile. The user interface control 730 can also include an answer of “YES” or “NO”. The user interface control 730 can be selected to toggle the answer between YES and NO. A link (e.g., the “SAVE” link as illustrated in FIG. 7) can be selected to save the selection. Such a saving action user input along with the user input toggling the answer on the user interface control 730 can provide user input to be sent to the processing plan service 250 from a client device 210 through which the user input was provided. The processing plan service 250 can receive the user input and can update the corresponding sender profile 320 with the setting selected by user input. The processing plan service 250 can access and use that setting in the sender profile 320 to determine which of multiple value transfer options are to be used for scheduled value transfers in processing plans 344 for transfers from that same sender profile 320 and receiver profile 310. For example, the first value transfer option can include processing plan value transfers being performed automatically via the value transfer processing system 200 without requiring user input (“YES” on the auto transfer option). A second value transfer option can include requiring user input confirming the processing plan value transfers prior to the processing plan value transfers being performed (“NO” on the auto transfer option). The user interface control 730 can also include an indication of whether the first value transfer option or the second value transfer option is currently selected, as illustrated in FIG. 7. Accordingly, this user interface control 730 or other alternative controls like it can allow for increased efficiency in value transfers, and also provide increased interactivity and control by the receiver profile 310, and therefor by the user corresponding to the receiver profile 310. Many different alternatives to the user interface control 730 could be used. For example, the user interface control may be in the form of a displayed drop-down menu or displayed toggle switch, or some other type of interactive user interface control. Also, the control may be applied to all transfers for the same receiver profile 310 and sender profile 320 as discussed above. However, it could apply differently, such as where it may be changed for each processing plan 344, or for all processing plans for a particular receiver profile 310, or at some other level within the value transfer processing system 200.

In addition to contact information for the sender profile 320, the customer overview dialog 720 can display aggregate data for the sender profile's processing plans 344 with the receiver profile 310. For example, this can include the total number of processing plans with the sender profile 320 (“TOTAL CONTRACTS” in the example) total amount of value transfers already received (“TOTAL FINANCING RECEIVED” in the example), balance of the total value still to be transferred under processing plans 344 from the sender profile 320 (“REMAINING BALANCE” in the example), and time-based rate increases to the amount to be transferred under processing plans 344 from the sender profile 320 (“INTEREST ACCRUED” in the example).

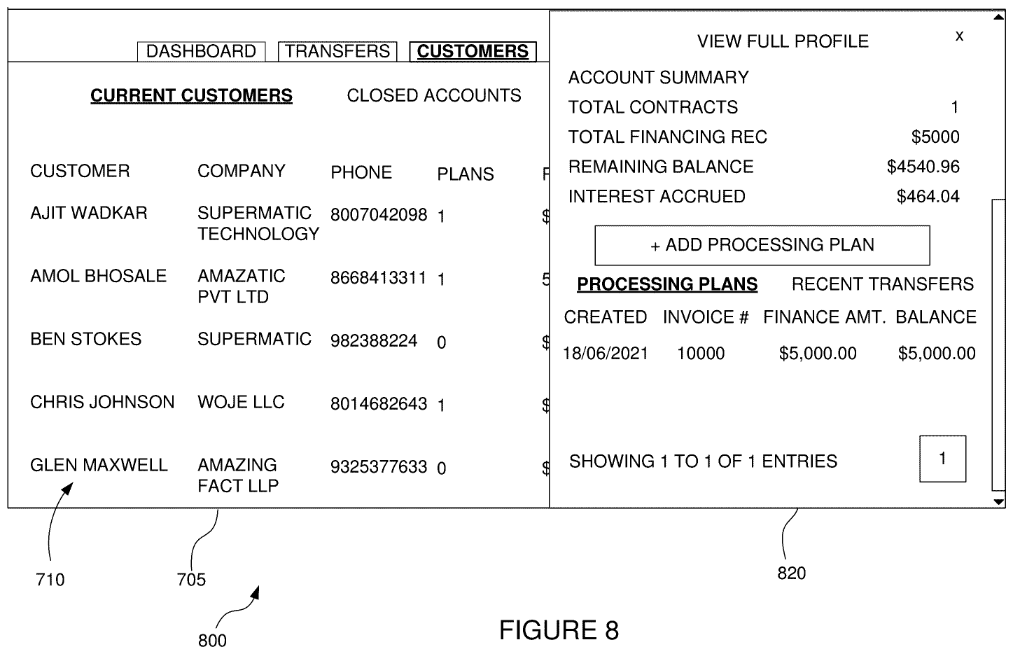

The customer overview dialog 720 can also include a link that can be selected to view additional information about the sender profile 320 (“VIEW FULL PROFILE” in the example). FIG. 8 illustrates a display screen 800 that can be displayed in response to user input selecting the “VIEW FULL PROFILE” link, including a view full customer profile dialog 820 in place of the customer overview dialog 720. The view full customer profile dialog 820 can include an account summary section, which can again display the total number of processing plans with the sender profile 320 (“TOTAL CONTRACTS” in the example) total amount of value transfers already received (“TOTAL FINANCING RECEIVED” in the example), balance of the total value still to be transferred under processing plans 344 from the sender profile 320 (“REMAINING BALANCE” in the example), and periodic time-based rate increases to the amount still to be transferred under processing plans 344 from the sender profile 320 (“INTEREST ACCRUED” in the example). The view full customer profile dialog 820 can also include a “PROCESSING PLANS” tab, which can be selected to display data for each of the processing plans 344 between the logged-in receiver profile 310 and the sender profile 320 being represented in the view full customer profile dialog 820. The view full customer profile dialog 820 can also include a “RECENT TRANSFERS” tab, which can be selected to display data for each of the recent value transfers between the logged-in receiver profile 310 and the sender profile 320 being represented in the view full customer profile dialog 820.

The view full customer profile dialog 820 can also include an “ADD PROCESSING PLAN” button, which can be selected by user input 362 to request the value transfer processing system 200 to display one or more user input requests 360 to retrieve user input 362 to define parameters for a new processing plan 344 and its associated processing plan rules 342.

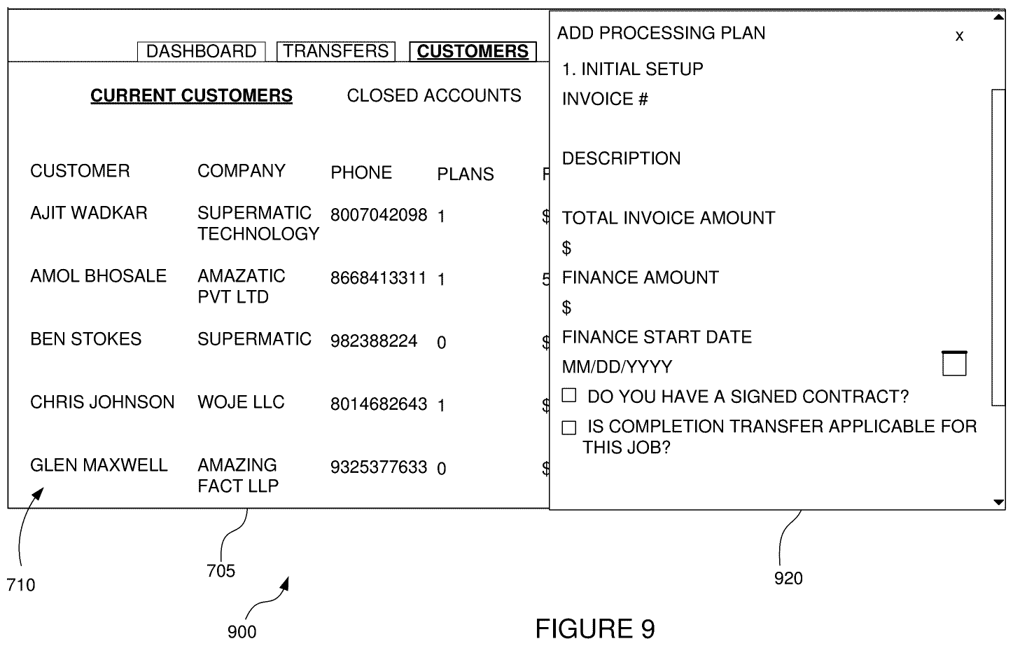

FIG. 9 illustrates a display screen 900 that can be displayed in response to user input selecting the “ADD PROCESSING PLAN” button, including a first add processing plan dialog 920 in place of the view full customer profile dialog 820. FIGS. 9-11 illustrate dialogs that request user input 362 to define a new processing plan 344 and associated processing plan rules 342 for the sender profile 320 that was represented in the view full customer profile dialog 820.

FIG. 9 illustrates a first portion of the first add processing plan dialog 920. That dialog requests user input 362 for the new processing plan 344, including an invoice number, a description, a total invoice amount (a total value amount including any value amounts transferred outside the processing plan service 250), a finance amount (a value amount to be transferred using the processing plan service 250 using the new processing plan 344), a finance start date (a start date for the processing plan 344), a check box for indicating that the receiver represented by the receiver profile 310 has a signed contract with the sender represented by the sender profile 320 for the processing plan 344, and a check box for indicating that a completion milestone value transfer is applicable for the processing plan 344.

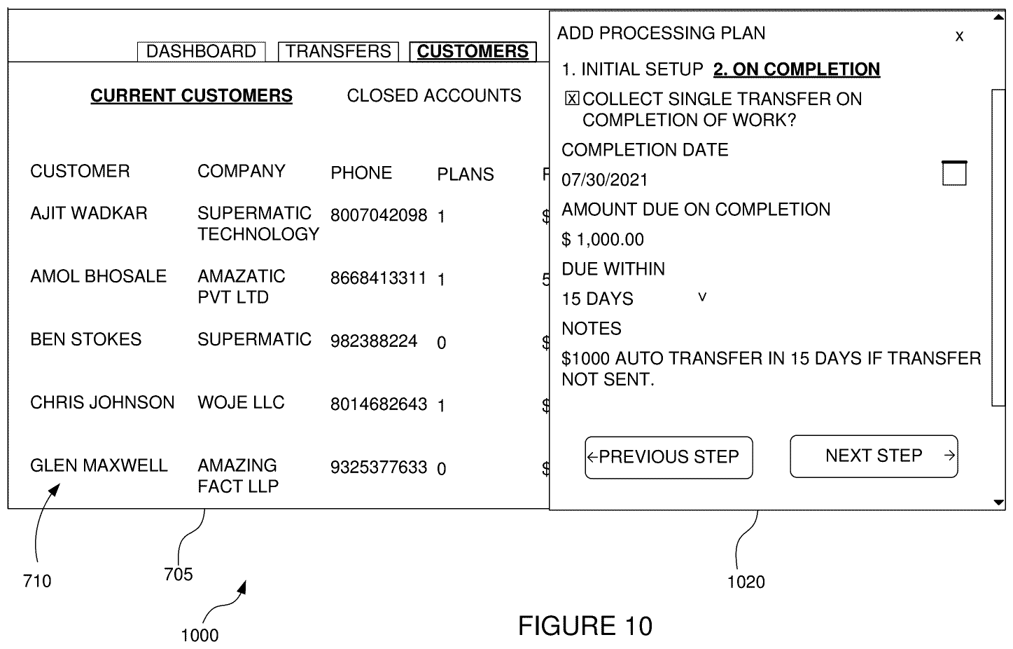

FIG. 10 illustrates a display screen 1000, which is like the display screen 900, but includes a second add processing plan dialog 1020 in place of the first section of the first add processing plan dialog 920 in the display screen 900. The second add processing plan dialog 1020 can request additional user input information for the new processing plan 344, including data regarding the completion milestone value transfer, which can include a completion date that is used to schedule the completion milestone value transfer, an “AMOUNT DUE ON COMPLETION” (a value amount scheduled to be transferred for the completion milestone, and a “DUE WITHIN” time, which indicates the amount of time between the completion date and the date that the completion value transfer will be scheduled (if a value transfer is not made in some other way prior to that date).

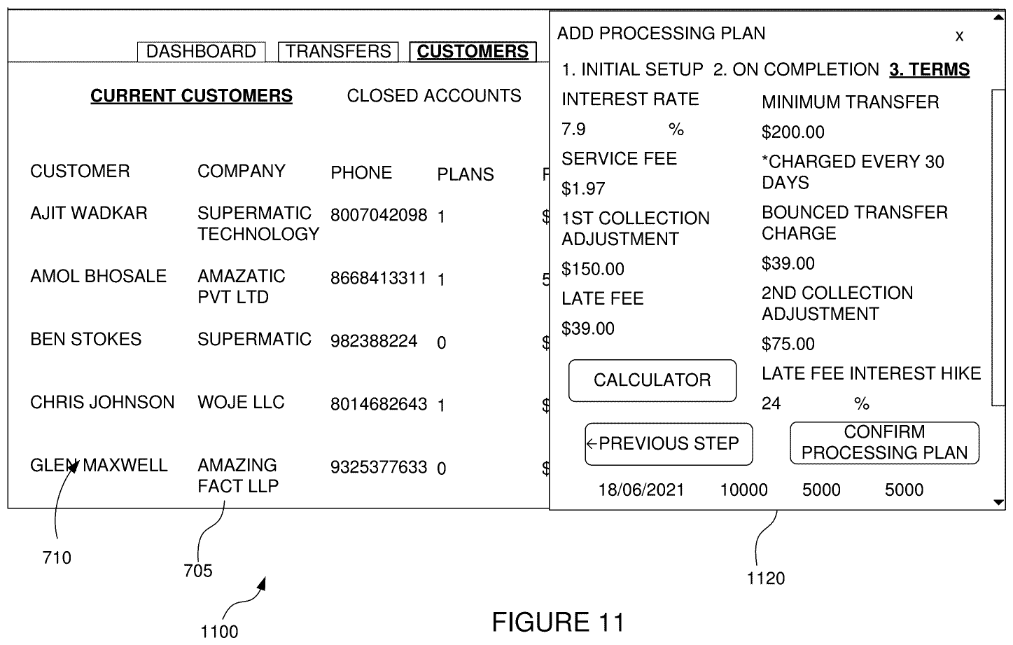

The second add processing plan dialog 1020 can also include a “PREVIOUS STEP” button that can be selected to request the display of the first add processing plan dialog 920, and a “NEXT STEP” button that can be selected to request the display of a third add processing plan dialog 1120 on a display screen 1100 illustrated in FIG. 11. The third add processing plan dialog 1120 can request additional information for the new processing plan 344, including data regarding value transfer terms that can be used in processing value transfers for the new processing plan 344 and in setting parameters for later changes that can be made to the processing plan 344 (such as in selecting fallback options in the event of failed value transfers). For example, the third add processing plan dialog 1120 can request user input to define an “INTEREST RATE” (an initial time-based rate for additions to amounts still to be processed under the processing plan 344), a “MINIMUM TRANSFER” (a minimum value transfer amount that will be scheduled periodically, such as every 30 days, using the processing plan 344), a service fee (an additional value amount to be added to each value transfer that is processed using the processing plan 344), a “BOUNCED TRANSFER” charge (a penalty value amount to be added to the value amount to be transferred using the processing plan 344 if a value transfer fails), a first collection adjustment (a default value amount to be used for a value transfer as a fallback option amount if a regular value transfer fails under the processing plan 344), a second collection adjustment (a default value amount to be used for a value transfer as a fallback option amount if a value transfer of the first collection adjustment fails under the processing plan 344), a late fee (a penalty fee to be added to the amount to be transferred under the processing plan 344 in response to a late value transfer under the processing plan 344), and a late fee interest hike (an increased time-based rate for additions to amounts still to be processed under the processing plan 344, with the increased amount to be used in response to late or failed value transfers under the processing plan 344). Thus, user input provided for creation of a processing plan can define an initial series of multiple scheduled transfers to occur for the processing plan to be created, and parameters for fallback options can be provided in case one or more of those scheduled transfer fails. In some situations, a processing plan may be created with only a single initial transfer. In that situation, fallback options to be used if that single transfer fails may include fallback options with multiple transfers that are each less than the single transfer. The third add processing plan dialog 1120 can also include a “PREVIOUS STEP” button that can be selected to display the second add processing plan dialog 1020, and a “CONFIRM PROCESSING PLAN” button that can be selected to confirm the creation of the new processing plan 344 using the user input data from the first add processing plan dialog 920, the second add processing plan dialog 1020, and the third add processing plan dialog 1120. This can result in the value transfer processing system 200 generating the processing plan 344 and the processing plan rules 342 for the new processing plan 344, and in storing the processing plan 344 and the processing plan rules 342 in the receiver database 274 for the logged-in receiver profile 310.

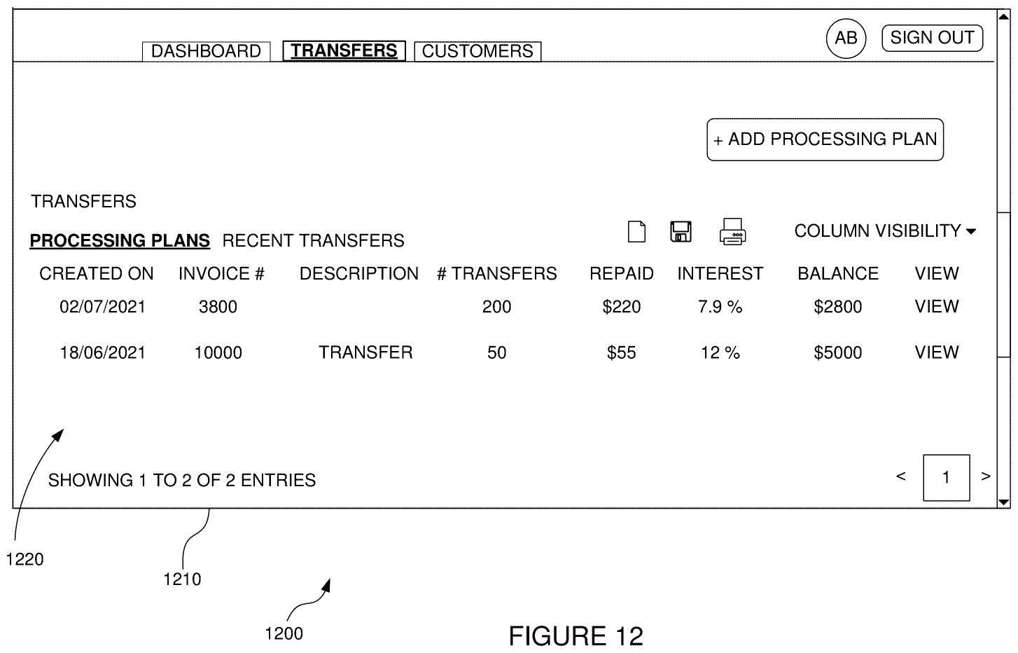

Referring now to FIG. 12, a display screen 1200 can include a customer transfers page 1210, which can include a list of value transfers between a sender profile 320 and the logged-in receiver profile 310. The customer transfers page 1210 can include a Processing Plans tab and a Recent Transfers tab. Selection of the Processing Plans tab can request the display of the processing plans list 1220 illustrated in FIG. 12, which can display information about processing plans for the logged-in receiver profile 310, with each row including data for a different processing plan 344. Selection of the Recent Transfers tab can request display of a similar list of recent value transfers. The customer transfers page 1210 can also include user interface controls, including an Add Processing Plan button, which can request the display of the add processing plan dialogs discussed above.

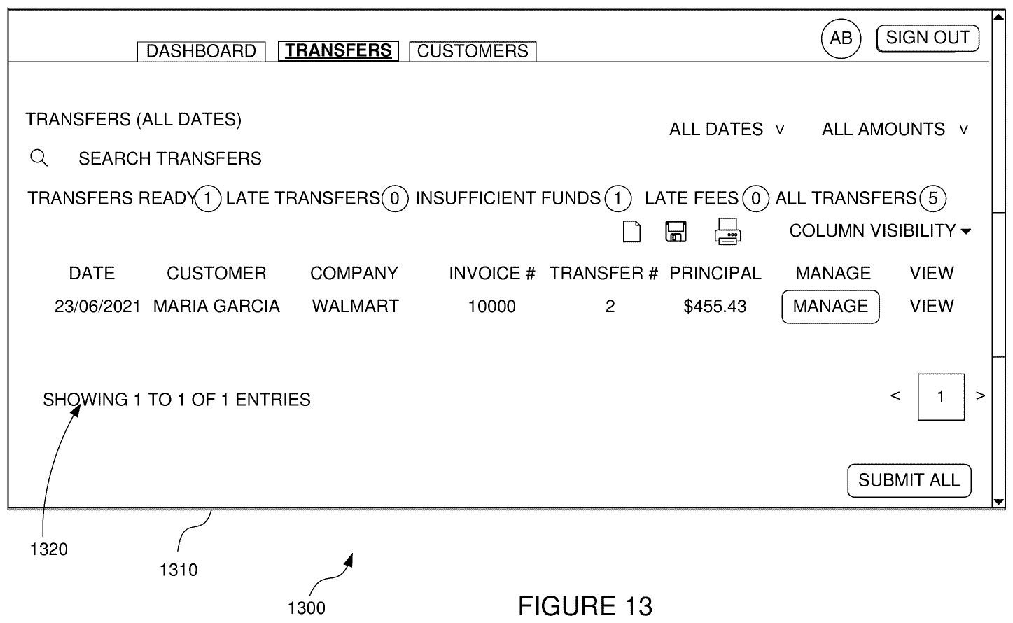

Referring now to FIG. 13, a display screen 1300 can include a transfers page 1310, which can be requested by user input selection of the “TRANSFERS” link at the top of the page. The transfers page 1310 can be configured to receive user input to filter which value transfers are listed in a value transfer list 1320, which can list value transfers meeting the requirements of the applied filters. For example, each list entry can list a date of the value transfer, a sender profile 320 (which may include a company and an individual name), an invoice number, an amount of the value transfer, and one or more user interface control buttons. For example, an entry can include a “MANAGE” button that can be selected to provide user input related to the value transfer, and a “VIEW” button that can be selected to request a display of additional data regarding the value transfer. As another example, an entry that is ready for a scheduled value transfer to be initiated can include a “SUBMIT” button that can be selected to provide user input confirming the value transfer and requesting the processing plan service 250 to initiate the value transfer.

In the example of the transfers page 1310, filter links can be displayed to be selected to apply corresponding filters. For example, these can include a “TRANSFERS READY” filter link that can be selected to list only value transfers that are ready to be confirmed for submission and initiation of the transfers, a “LATE TRANSFERS” filter link that can be selected to display value transfers that are currently late, an “INSUFFICIENT FUNDS” filter link that can be selected to list only value transfers that have failed due to insufficient value amounts being available from the sender profile's value record 242, a “LATE FEES” filter link that can be selected to list late fees that can be managed and/or initiated in response to user input, and an “ALL TRANSFERS” filter link that can be selected to list all value transfers without filtering to one of the preceding categories. Accordingly, list items in the filtered value transfer list 1320 can act as displayed notifications 366 regarding value transfers.

The transfers page can also include additional user interface controls that can be selected to apply other types of filters to the value transfer list 1320, including a keyword filter (by typing in the text box labeled “SEARCH TRANSFERS”), a date filter (by selecting the arrow to the right of the words “ALL DATES” to reveal a drop-down menu for date filtering and selecting one of the menu options), and an amount filter (by selecting the arrow to the right of the words “ALL AMOUNTS” to reveal a drop-down menu for amount filtering and selecting one of the menu options). The transfers page 1310 can also include additional controls that can respond to user input selections.

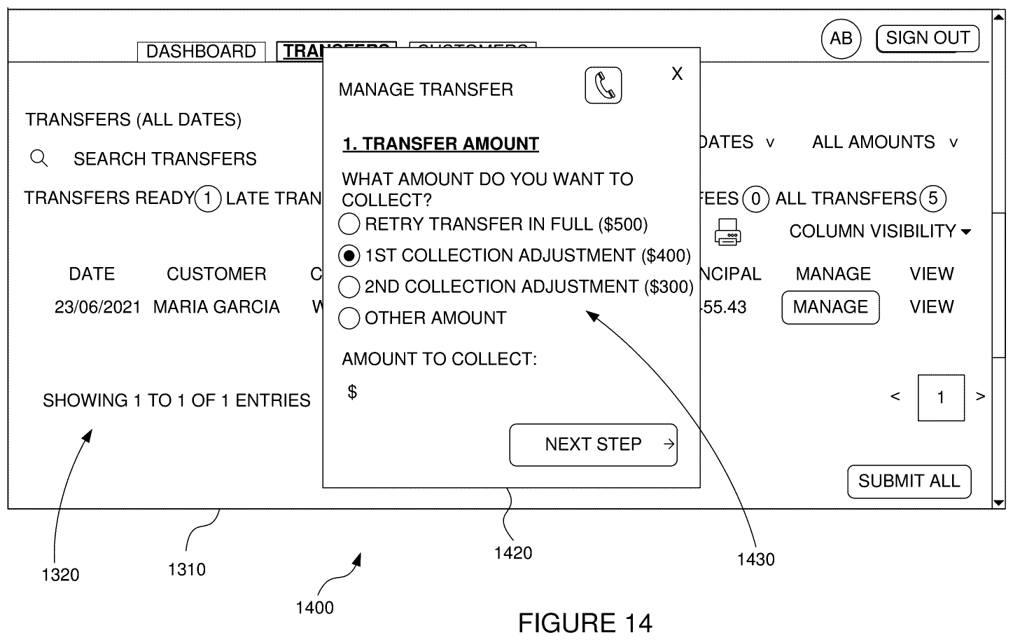

Selection of the “MANAGE” button for a listed value transfer after selecting the Insufficient Funds filter link can request display of a first manage transfer dialog 1420, as illustrated in a display screen 1400 of FIG. 14. The first manage transfer dialog 1420 can include a transfer amount user input request 1430, which can request user input to select a fallback option for an amount of a value transfer to attempt after an initial value transfer has failed due to an insufficient available value amount to be transferred. The transfer amount user input request can include a list of default amounts, including retrying the value transfer in full, trying a listed first collection adjustment amount (which may be specified in the processing plan rules 342), a listed second collection adjustment amount (which may be specified in the processing plan rules 342), or another amount that can be entered by user input so long as it is within parameters set in the processing plan rules 342 and/or the receiver processing rules 330.

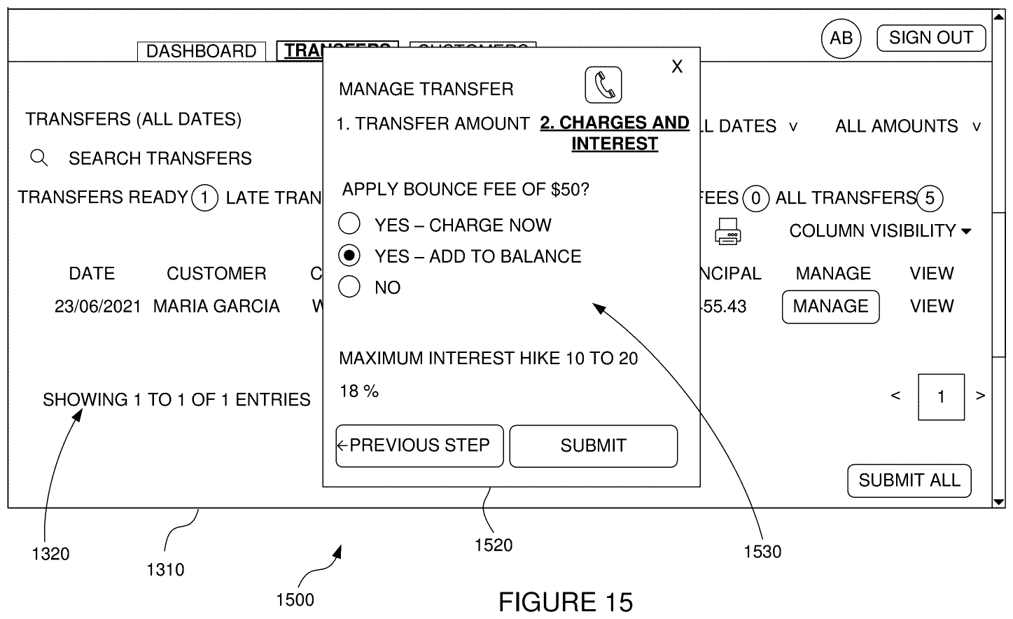

The first manage transfer dialog 1420 can also include a “NEXT STEP” button that can be selected to request display of a second manage transfer dialog 1520 illustrated in a display screen 1500 of FIG. 15. The second manage transfer dialog 1520 can include a charges and interest user input request 1530, which can request user input to select fallback options for a failed value transfer penalty (“BOUNCE FEE”), and an interest hike, which can be an increased time-based rate in the form of an increased rate of interest to be charged in the future for a balance of amounts still to be transferred under the processing plan 344 after the failed value transfer. The interest rate can be increased to an amount between a specified minimum amount and a specified maximum amount. These minimums and maximums can be specified in the receiver processing rules 330 and/or the processing plan rules 342. The interest, or time-based rates periodically added to amounts to be transferred under the processing plans 344, may be compounded at a specified period, such as daily, monthly, or annually.

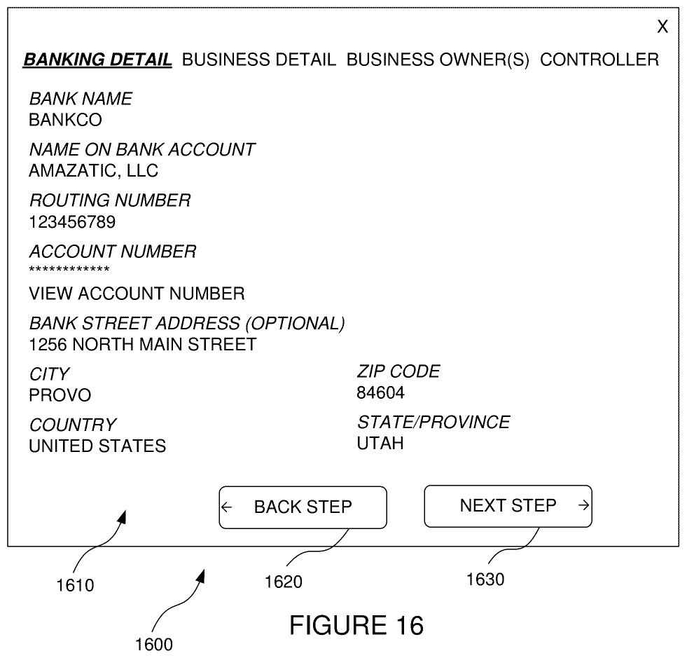

Referring now to FIGS. 16-19, display screens for collecting data for a receiver profile 310 are discussed. These screens may be displayed before allowing a new receiver profile 310 to generate processing plans 344 using the value transfer processing system 200. Some of the data to be received in the screens may be required, and other data may be optional.

Referring to FIG. 16, a banking detail display screen 1600 for entering banking details can include bank details for the receiver profile 310. For example, the banking detail display screen can include text boxes 1610 for entering the banking details. These banking details may include the bank name, the name on the bank account (such as the name of an individual user or organization to whom the bank account belongs), a bank routing number (or other similar number such as a SWIFT number, etc.), an account number, and address information for the bank, such as a street address, city, country, zip code, and state or province. The display screen 1600 can also include navigation buttons or links, such as a “BACK STEP” button 1620, which can be selected to navigate to a previous screen, and a “NEXT STEP” button 1630, which can be selected to navigate to the next screen. The display screen 1600 and the other data collection screens in FIGS. 16-19 can also include a list indicating all the data collection screens in the data collection sequence for the receiver profile 310, with the currently-displayed screen highlighted (in FIG. 16, the words “BANKING DETAIL” in the list is highlighted).

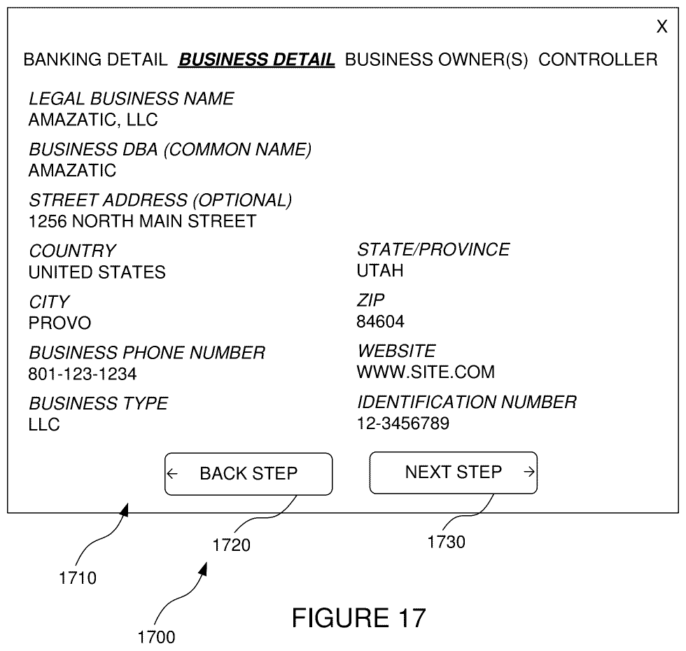

User input can be provided to enter the requested data into the banking detail display screen 1600. The next step button 1630 can be selected by user input to save the data entered on the banking detail display screen and display the next display screen, which can be a business detail display screen 1700, as illustrated in FIG. 17.

The business detail display screen 1700 can include the display screen list like in FIG. 16, but with the words “BUSINESS DETAIL” highlighted in the list of screens. The business detail display screen 1700 can include text boxes 1710 for entering the business details for the sender profile 320. These business details may include the legal business name, the business DBA (doing-business-as name, or common name used for the business), and contact information for the business, such as a street address, city, country, zip code, state or province, phone number, and website. The business details may also include other data such as the entity type for the business of the sender profile 320 and an identification number, such as a government identification number for the business (e.g., a federal employer identification number in the United States of America). The display screen 1700 can also include navigation buttons or links, such as a “BACK STEP” button 1720, which can be selected to navigate to a previous screen, and a “NEXT STEP” button 1730, which can be selected to navigate to the next screen.

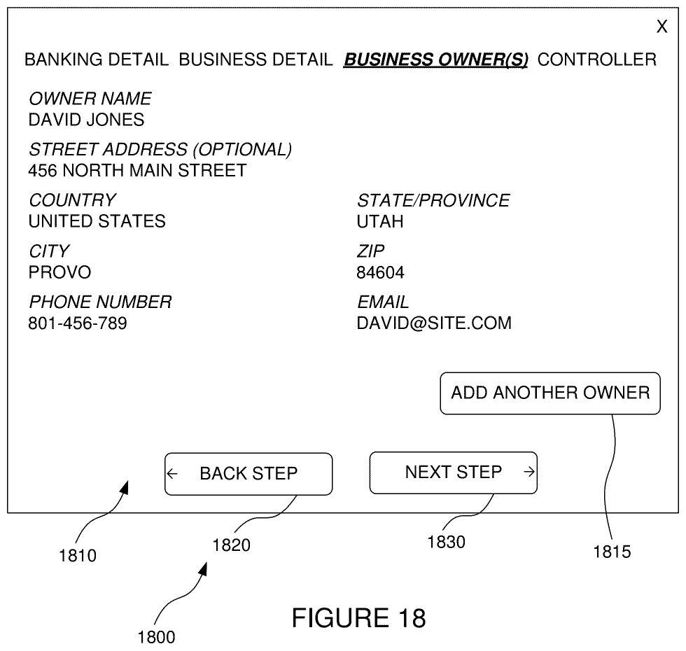

User input can be provided to enter the requested data into the business detail display screen 1700. The NEXT STEP button 1730 can be selected by user input to save the data entered on the business detail display screen and display the next display screen, which can be a business owner display screen 1800, as illustrated in FIG. 18.

The business owner display screen 1800 can include the display screen list like in FIG. 16, but with the words BUSINESS OWNER(S) highlighted in the list of screens. The business owner display screen 1800 can include text boxes 1810 for entering the details for one or more owners of the business corresponding to the sender profile 320. These owner details may include the owner's name and contact information for the owner, such as a street address, city, country, zip code, state or province, phone number, and email address. The business owner display screen 1800 can also include a user interface control such as an add owner button 1815 that can be selected to add additional text boxes to enter data for an additional owner. The add owner button 1815 can remain on the business owner display screen 1800 after addition of one or more owners, to allow selection for adding even more owners' data to the business owner display screen 1800. The business owner display screen 1800 can also include navigation buttons or links, such as a “BACK STEP” button 1820, which can be selected to navigate to a previous screen, and a “NEXT STEP” button 1830, which can be selected to navigate to the next screen.

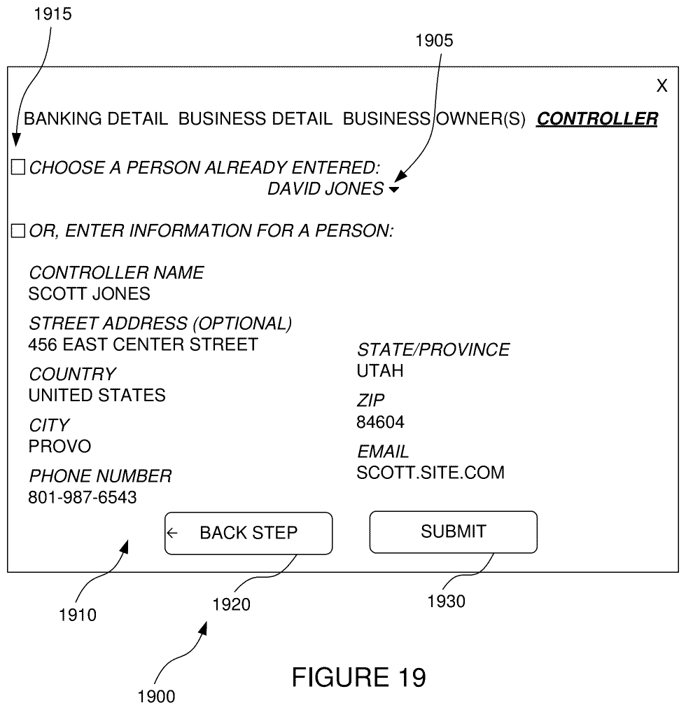

User input can be provided to enter the requested data into the business owner display screen 1800. The next step button 1830 can be selected by user input to save the data entered on the business owner display screen 1800 and display the next display screen, which can be a controller display screen 1900, as illustrated in FIG. 19.

The controller display screen 1900 can include the display screen list like in FIG. 16, but with the words CONTROLLER highlighted in the list of screens. The controller display screen 1900 can include a user interface control 1905 to receive user input to select a person already entered (such as a person entered as a business owner). The controller display screen 1900 can also include text boxes 1910 for alternatively entering the details for a controller of the business corresponding to the receiver profile 310. The display screen 1900 can also include one or more user interface controls 1915, such as one or more check boxes, to indicate whether the controller is to be a previously entered person that is selected, or a person whose information is newly entered in the text boxes 1910. These controller details may include the controller's name and contact information for the controller, such as a street address, city, country, zip code, state or province, phone number, and email address. The controller display screen 1900 can also include a user interface control such as an add controller button that can be selected to add additional text boxes to enter data for an additional owner (as with the button on the business owner display screen 1800, though such an add controller button is not illustrated in FIG. 19). The controller display screen 1900 can also include navigation buttons or links, such as a “BACK STEP” button 1920, which can be selected to navigate to a previous screen, and a “SUBMIT” button 1930, which can be selected to save and submit the data for the receiver profile 310.

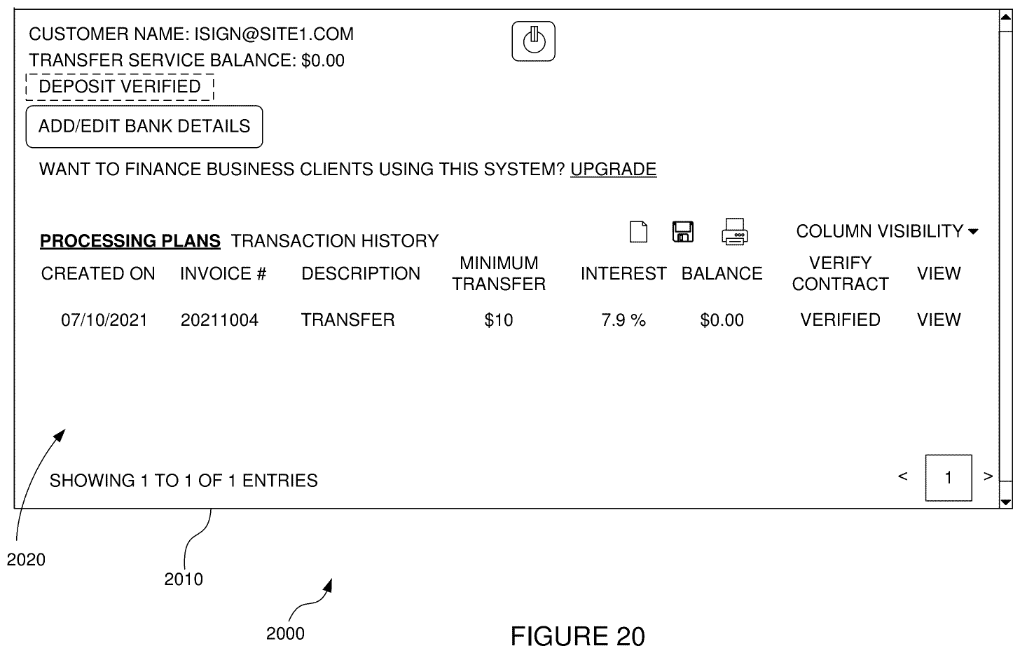

FIGS. 20-22 illustrate display screens that can be displayed for sender profiles 320, such as for displaying data regarding a sender profile's processing plans and history of transfers. Referring now to FIG. 20, a display screen 2000 can include a transfer page 2010, which can include a header section with general information, such as a customer name, a transfer service balance (a balance of value the sender profile 320 has with a processing plan service, transfer gateway, value tracking service, or some other service), an indication of whether a deposit for the sender profile 320 has been verified (such as by making and verifying amounts of micro deposits in a bank account for the sender profile 320), a link to add and/or edit bank details for the sender profile 320, and a link for the sender profile 320 to upgrade to allow the sender profile 320 to also act as a receiver profile 310 with the system. The transfer page 2010 can also include tabs that can be selected to display different tabbed sections of the transfer page 2010. As illustrated in FIG. 20, the tabs include a PROCESSING PLANS tab and a TRANSACTION HISTORY tab. In FIG. 20, the PROCESSING PLANS tab is selected to display a processing plan section 2020, with can include data about processing plans 344 for the sender profile 320. For example, this data can include, for each processing plan 344 a creation date, an invoice number, a description, a minimum transfer, and interest rate, a balance, and an indication of whether it has been verified that a contract has been entered for the processing plan 344. The data for each processing plan 344 can also include a “VIEW” indication, which can be selected by user input to display additional data regarding the corresponding processing plan 344.

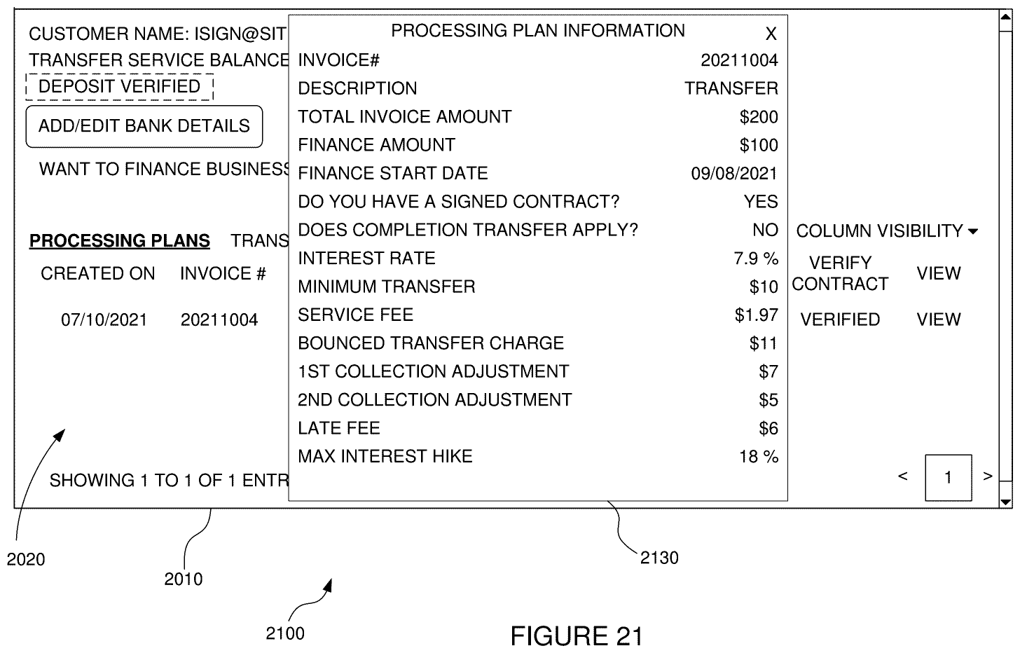

For, example, as illustrated in the display screen 2100 of FIG. 21, this display of additional data can be displayed in a display page such as a dialog 2130. For example, the data displayed can include an invoice number; a description; a total invoice amount; a finance amount (an amount of value that is to be transferred in additional periodic transfers, possibly with time-based added value (such as monetary interest) being added to the amount due to be transferred); a finance start date (when the periodic transfers will begin); an indication of whether there is a signed contract for the processing plan; an indication of whether a completion transfer applies (whether a transfer will be made after completion some specified occurrence); an interest rate; a minimum transfer; a service fee; a bounced transfer charge; a first collection adjustment; a second collection adjustment; a late fee; and a max interest rate hike (a maximum increased time-based rate for additions to amounts still to be processed under the processing plan 344, with the increased amount to be used in response to late or failed value transfers under the processing plan 344). The dialog 2130 can be closed in response to user input selection of a dialog closing user interface control, such as a control displayed as an “X” in an upper left corner of the dialog 2130.

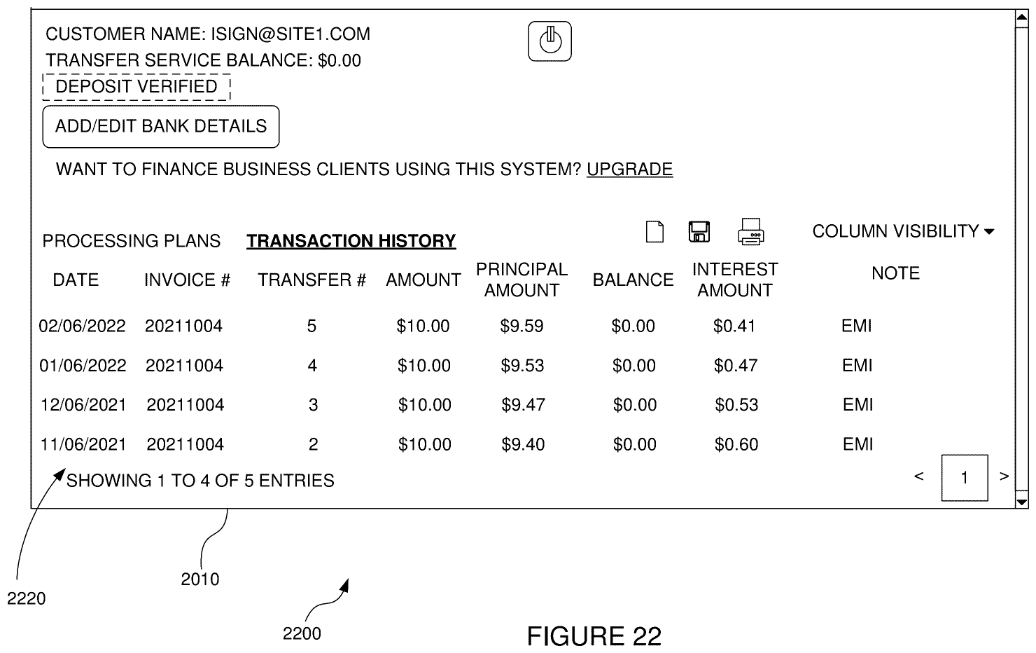

Selection of the TRANSACTION HISTORY tab on the page 2010 can reveal a transaction history section 2220 in place of the processing plan section 2020, as illustrated in the display screen 2200 of FIG. 22. The transaction history section 2220 can include rows that each include data regarding a transfer for the sender profile 320. For example, the data may include a transfer date, an invoice number, a transfer number (a sequential number for value transfers made according to a processing plan 344), an amount of the transfer, a principal amount of the transfer that goes to decrease the balance of value still to be transferred, a balance (which may be a current balance, as shown, or a balance at the time of the transfer in an alternative implementation), an interest amount of the transfer that is applied to the interest amounts that have been applied, and a textual note about the transfer.

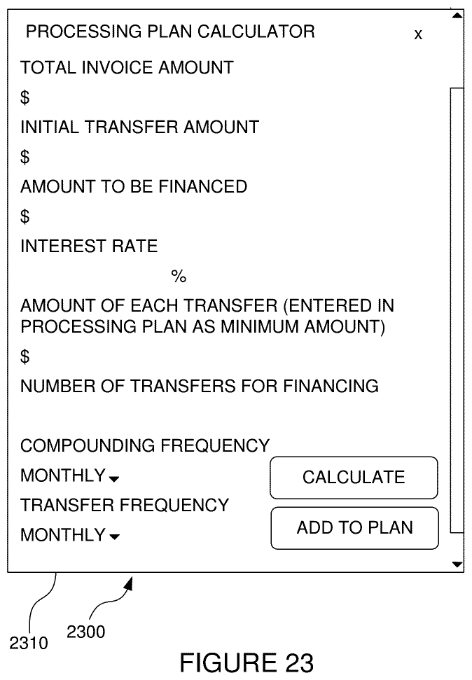

Referring now to FIG. 23, a display screen 2300 is illustrated. The display screen 2300 can include a calculator dialog 2310. The dialog 2310 may be displayed and used in response to a user selecting a user interface control such as a button. For example, such a user interface control may be displayed on a dialog for adding a processing plan 344, as illustrated in the “CALCULATOR” button displayed on the third add processing plan dialog 1120 of FIG. 11.

The calculator dialog 2310 can include user interface controls for entering values for terms to be applied to a processing plan 344. User input can be provided to enter some values, and user input can be provided to direct the system to calculate other values from the entered values, such as by selecting a CALCULATE button, such as the button illustrated in FIG. 23. For example, the calculator dialog 2310 can include a text box for a total invoice amount, an amount to be financed, an interest rate, an amount for each periodic scheduled transfer transferring the amount to be financed, a number of transfers for transferring the amount to be financed, a compounding frequency (e.g., monthly, daily, quarterly, annually), and a transfer frequency (e.g., monthly, daily, quarterly, annually). As an example, user input can choose the monthly compounding frequency, the monthly transfer frequency, and can enter a total invoice amount, an initial transfer amount, an interest rate (which can be an annual interest rate), and a number of monthly transfers. From this, the calculator can calculate an amount to be financed (the total invoice amount minus the initial transfer amount), and the amount of each monthly transfer (using compound interest calculations). For example, if the total invoice amount is entered as $1200, the initial transfer amount is entered as $200, the interest rate is entered as 8%, and the number of transfers is entered as 12, then the amount to be financed can be calculated as $1000, and the amount of the monthly transfers can be calculated as $86.99. Of course, different calculations can be made, such as calculating the number of payments from the other values, calculating the interest rate from the other values, etc. The values that are entered by user input and calculated from the user input values (including the payment frequency and the compounding frequency) can be entered by the computer system as values in the processing plan 344 being created and/or in processing plan creation dialog screens after user input so indicating, such as user input selecting an “ADD TO PLAN” button illustrated in FIG. 23. Also, the calculator dialog 2310 can be closed in response to user input selecting an “X” user interface control, such as the one in the upper right corner of the calculator dialog 2310.

While examples of displays are discussed above and illustrated in the figures, different displays and/or other types of presentations (such as audible presentations of data), and other techniques for receiving user input (e.g., voice to text tools) may be used. The value transfer processing system 200 can also include additional displays besides those illustrated and discussed above.

### III. Value Transfer Processing Plan Techniques

Value transfer processing plan techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic. Features discussed in each of the techniques below may be combined with each other in any combination not precluded by the discussion herein, including combining features from a technique discussed with reference to one figure in a technique discussed with reference to a different figure. Also, a computer system may include means for performing each of the acts discussed in the context of these techniques, in different combinations.

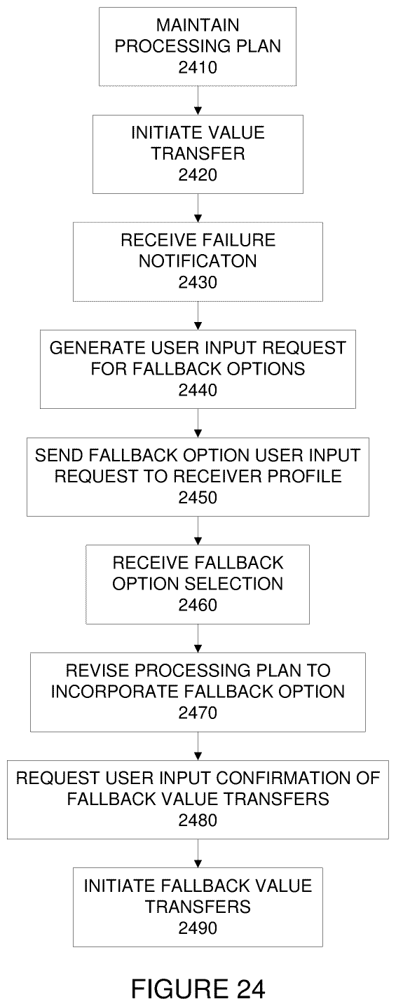

Referring to FIG. 24, a value transfer processing plan technique will be discussed. The technique can include maintaining 2410 a processing plan in the computer system according to one or more processing plan rules in the computer system, with the processing plan including parameters for one or more initial value transfers from a sender profile to a receiver profile to transfer an initial overall value amount. The technique can also include initiating 2420 one of the one or more initial value transfers in the computer system using the processing plan, and receiving 2430 a processing failure notification in the computer system, the processing failure notification indicating that the one of the one or more initial value transfers has failed. The technique can include generating 2440 a user input request, the user input request including an indication of a failure of the one of the one or more initial value transfers, and the user input request further including a request for user input to choose between multiple alternative fallback options to change the processing plan, the alternative fallback options being specified in the processing plan rules. Responsive to the receiving of the processing failure notification, the technique can include sending 2450 the user input request to the receiver profile via the computer system. The technique can further include receiving 2460 from the receiver profile a computer-readable user input selection of a first fallback option of the alternative fallback options in the user input request, the first fallback option including multiple scheduled fallback value transfers that are each for amounts that are less than an amount of the one of the one or more initial value transfers, with the first fallback option changing the processing plan to transfer a fallback overall value amount that is greater than the initial overall value amount (such as where a single failed value transfer is replaced with a series of multiple periodic value transfers with interest being added to the transferred amounts, even if the initial processing plan did not include accrual of interest under the plan). Moreover, the technique can include revising 2470 the processing plan to incorporate the first fallback option. Additionally, the technique can include requesting 2480 user input confirmation from the receiving profile for initiation of each of the multiple scheduled fallback value transfers according to the processing plan. The technique can also include initiating 2490 each of the multiple scheduled fallback value transfers in response to the user input confirmation. Alternatively, the technique may include automatically performing the scheduled fallback value transfers, which may include initiating and performing the scheduled fallback transfers without requesting or receiving user input confirmation for the transfers.

The one or more initial value transfers may include only the one of the one or more initial value transfers, and the processing plan can specify no more than the one of the one or more initial value transfers.

A user interface control can be presented. The user interface control can be designed to receive user input to indicate selection of a value transfer option from a plurality of available value transfer options, including a first value transfer option and a second value transfer option. The first value transfer option can include processing plan value transfers being performed automatically via the value transfer computer system without requiring user input. The second value transfer option can include requiring user input confirming the processing plan value transfers prior to the processing plan value transfers being performed. Also, the user interface control can further include an indication of whether the first value transfer option or the second value transfer option is currently selected. User input directed at the user interface control can be received. The user input can indicate a selection of a selected value transfer option that is either the first value transfer option or the second value transfer option. In response to the receiving of the user input directed at the user interface control, the user interface control can be changed from a first display state to a second display state, indicating the selection of the selected value transfer option. The selection of the selected value transfer option can result in the initiating of each of the multiple scheduled fallback value transfers being performed according to the selected value transfer option.

The initiating of the one of the one or more initial value transfers can be performed in response to receiving a user input confirmation from the receiver profile. Also, the processing plan can indicate that the one of the one or more initial value transfers is to be initiated upon completion of a milestone, such as completion of a job or delivery of items.

The processing plan can indicate that the one of the one or more initial value transfers is one of multiple scheduled periodic value transfers as part of the processing plan with an initial time-based rate for periodic additional value amounts to be added to value amounts to be transferred using the processing plan, and the first fallback option can include increasing the initial time-based rate to a fallback time-based rate that is greater than the initial time-based rate.

The alternative fallback options can include multiple different time-based rates for periodic additional value amounts to be added to value amounts to be transferred using the processing plan, and the technique can include calculating values for the multiple scheduled fallback value transfers using a time-based rate in the first fallback option. The processing plan rules can include a maximum time-based rate for periodic additional value amounts to be added to value amounts to be transferred using the processing plan.

The technique can include sending a calculator page to a computing device, the calculator page being configured to display a set of values related to the processing plan rules, the calculator page comprising user interface controls that are configured to receive any of multiple different subsets of the set of values, and the computer system being configured to calculate remaining values in the set of values that are not in a chosen one of the different subsets of the set of values. The calculator page can include a submission user interface control that is selectable to submit current values from the calculator page to be included in the processing plan rules.

The technique can also include performing the following in response to a user input selection of the submission user interface control: receiving the current values from the calculator page; and including the current values in the processing plan rules. The technique can also include generating the processing plan rules. The generating of the processing plan rules can include the receiving of the current values from the calculator page and the including of the current values in the processing plan rules.

Changing the processing plan can include calculating values of the scheduled fallback value transfers using an interest rate specified in the first fallback option. This may be done where the processing plan did not include additional values from interest rates prior to applying the first fallback option to the processing plan.

The first fallback option can include adding a penalty value for the failure of the one of the initial value transfers.

The technique can further include generating the processing plan rules and the processing plan in response to user input selecting parameters for inclusion in the processing plan rules and the processing plan. The user input selecting parameters for inclusion in the processing plan rules and the processing plan can include user input selecting contract provisions. Also, the technique can further include generating a digital textual natural language contract using the user input selecting the contract provisions, and the technique can also include sending user input requests that request user input from the sender profile and the receiver profile to confirm agreement with the digital textual natural language contract.

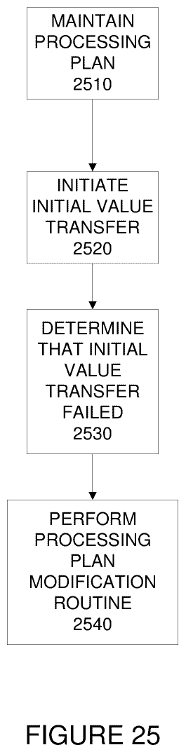

Referring now to FIG. 25, another technique is discussed. The technique can include maintaining 2510 a processing plan in a computer system according to one or more processing plan rules in the computer system. The processing plan can include parameters for only one initial value transfer from a sender profile to a receiver profile to transfer an initial overall value amount. The technique can further include initiating 2520 the initial value transfer in the computer system using the processing plan, and determining 2530 that the initial value transfer has failed. In response to determining that the initial value transfer has failed, the technique can include performing 2540 a processing plan modification routine. The processing plan modification routine can include revising the processing plan to incorporate a fallback option allowed in the processing plan rules. The fallback option can include multiple scheduled fallback value transfers that are each for amounts that are less than an amount of the initial value transfer. The fallback option can change the processing plan to transfer a fallback overall value amount that is greater than the initial overall value amount. The technique can further include initiating each of the multiple scheduled fallback value transfers.

The fallback option can be a first fallback option and the technique of FIG. 25 can include additional acts. For example, the technique can include receiving a processing failure notification in the computer system, with the processing failure notification indicating that the initial value transfer has failed. A user input request can be generated. The user input request can include an indication of a failure of the initial value transfer. The user input request can further include a request for user input to choose between multiple alternative fallback options to change the processing plan, the alternative fallback options being allowed in the processing plan rules. For example, choosing between the multiple fallback options could include choosing between different displayed options with different transfer amounts, interest rates and/or other values (such as choosing between a displayed option for an interest rate of 15% and a displayed interest rate of 25%). Choosing between the multiple fallback options may include indicating values within specified allowable ranges (such as choosing an interest rate between an allowable range between 7.9% and 25%—for example, user input choose by indicating a 15% rate). The alternative fallback options can be allowed in the processing plan rules. Additionally, in response to receiving of the processing failure notification, the user input request can be sent to the receiver profile via the computer system. Also, a computer-readable user input selection of the first fallback option of the alternative fallback options in the user input request can be received from the receiver user profile. The processing plan can be revised to incorporate the first fallback option.

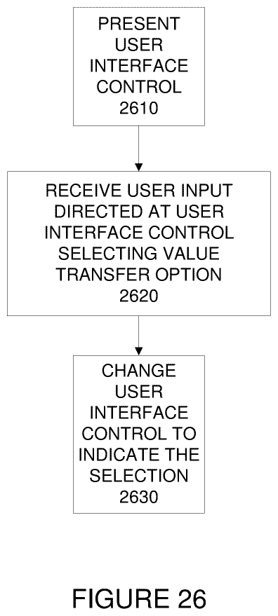

Referring to FIG. 26, yet another technique will be discussed. The technique can include, in a value transfer computer system, presenting 2610 a user interface control that is designed to receive user input to indicate selection of a value transfer option from a plurality of available value transfer options, which can include a first value transfer option and a second value transfer option. The first value transfer option can include processing plan value transfers being performed automatically via the value transfer computer system without requiring user input. The second value transfer option can include requiring user input confirming the processing plan value transfers prior to the processing plan value transfers being performed. The user interface control can further include an indication of whether the first value transfer option or the second value transfer option is currently selected. The technique can also include receiving 2620 user input directed at the user interface control indicating a selection of a selected value transfer option that is either the first value transfer option or the second value transfer option. Further, the technique can include, in response to the receiving of the user input directed at the user interface control, changing 2630 the user interface control from a first display state to a second display state to indicate the selection of the selected value transfer option.

The technique of FIG. 26 can further include initiating value transfers according to a processing plan using the selected value transfer option. For example, if the first value transfer option is selected, this can include processing plan value transfers being performed automatically via the value transfer computer system without requiring user input. If the second value transfer option is selected, this can include requiring user input confirming the processing plan value transfers prior to the processing plan value transfers being performed, so that each processing plan value transfer is initiated only after requesting and receiving user input confirming that the transfer is to be made.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims below or other claims that may be made.

I/We claim:

1. A computer system comprising:
at least one processor; and
memory comprising instructions stored thereon that when executed by at least one processor cause at least one processor to perform acts comprising:
maintaining a processing plan in the computer system according to one or more processing plan rules in the computer system, the processing plan comprising parameters for one or more initial value transfers from a sender profile to a receiver profile to transfer an initial overall value amount;
initiating one of the one or more initial value transfers in the computer system using the processing plan;
receiving a processing failure notification in the computer system, the processing failure notification indicating that the one of the one or more initial value transfers has failed;
generating a user input request, the user input request including an indication of a failure of the one of the one or more initial value transfers, and the user input request further including a request for user input to choose between multiple alternative fallback options to change the processing plan, the alternative fallback options being allowed in the processing plan rules;
responsive to the receiving of the processing failure notification, sending the user input request to the receiver profile via the computer system;
receiving from the receiver profile a computer-readable user input selection of a first fallback option of the alternative fallback options in the user input request, the first fallback option comprising multiple scheduled fallback value transfers that are each for amounts that are less than an amount of the one of the one or more initial value transfers, the first fallback option changing the processing plan to transfer a fallback overall value amount that is greater than the initial overall value amount;
revising the processing plan to incorporate the first fallback option; and
initiating each of the multiple scheduled fallback value transfers.

2. The computer system of claim 1, wherein the acts further comprise requesting user input confirmation from the receiving profile for initiation of each of the multiple scheduled fallback value transfers according to the processing plan, and wherein the initiating of each of the multiple scheduled fallback value transfers is performed in response to a corresponding user input confirmation.

3. The computer system of claim 1, wherein the one or more initial value transfers include only the one of the one or more initial value transfers, and wherein the processing plan specifies no more than the one of the one or more initial value transfers.

4. The computer system of claim 1, wherein the acts further comprise:
in the computer system, presenting a user interface control that is designed to receive user input to indicate selection of a value transfer option from a plurality of available value transfer options comprising a first value transfer option and a second value transfer option, wherein the first value transfer option comprises processing plan value transfers being performed automatically via the computer system without requiring user input, wherein the second value transfer option comprises requiring user input confirming the processing plan value transfers prior to the processing plan value transfers being performed, and wherein the user interface control further comprises an indication of whether the first value transfer option or the second value transfer option is currently selected;
receiving user input directed at the user interface control indicating a selection of a selected value transfer option that is either the first value transfer option or the second value transfer option; and
in response to the receiving of the user input directed at the user interface control, changing the user interface control from a first display state to a second display state to indicate the selection of the selected value transfer option, wherein the selection of the selected value transfer option results in the initiating of each of the multiple scheduled fallback value transfers being performed according to the selected value transfer option.

5. The computer system of claim 1, wherein the initiating of the one of the one or more initial value transfers is performed in response to receiving a user input confirmation from the receiver profile.

6. The computer system of claim 3, wherein the processing plan indicates that the one of the one or more initial value transfers is to be initiated upon completion of a milestone.

7. The computer system of claim 1, wherein the processing plan indicates that the one of the one or more initial value transfers is one of multiple scheduled periodic value transfers as part of the processing plan with an initial time-based rate for periodic additional value amounts to be added to value amounts to be transferred using the processing plan, and wherein the first fallback option comprises increasing the initial time-based rate to a fallback time-based rate that is greater than the initial time-based rate.

8. The computer system of claim 1, wherein the alternative fallback options comprise multiple different time-based rates for periodic additional value amounts to be added to value amounts to be transferred using the processing plan, and wherein the acts comprise calculating values for the multiple scheduled fallback value transfers using a time-based rate in the first fallback option.

9. The computer system of claim 8, wherein the processing plan rules comprise a maximum time-based rate for periodic additional value amounts to be added to value amounts to be transferred using the processing plan.

10. The computer system of claim 1, wherein the acts comprise sending a calculator page to a computing device, the calculator page being configured to display a set of values related to the processing plan rules, the calculator page comprising user interface controls that are configured to receive any of multiple different subsets of the set of values, and the computer system being configured to calculate remaining values in the set of values that are not in a chosen one of the different subsets of the set of values.

11. The computer system of claim 10, wherein the calculator page comprises a submission user interface control that is selectable to submit current values from the calculator page to be included in the processing plan rules.

12. The computer system of claim 11, wherein the acts comprise the following in response to a user input selection of the submission user interface control:
receiving the current values from the calculator page; and
including the current values in the processing plan rules.

13. The computer system of claim 12, wherein the acts comprise generating the processing plan rules, and wherein generating the processing plan rules comprises:
the receiving of the current values from the calculator page; and
the including of the current values in the processing plan rules.

14. The computer system of claim 1, wherein changing the processing plan comprises calculating values of the scheduled fallback value transfers using an interest rate specified in the first fallback option, wherein the processing plan did not include additional values from interest rates prior to applying the first fallback option to the processing plan.

15. The computer system of claim 1, wherein the first fallback option comprises adding a penalty value for the failure of the one of the initial value transfers.

16. The computer system of claim 1, wherein the acts further comprise generating the processing plan rules and the processing plan in response to user input selecting parameters for inclusion in the processing plan rules and the processing plan, wherein the user input selecting the parameters comprises user input selecting contract provisions, and wherein the acts further comprise:
generating a digital textual natural language contract using the user input selecting the contract provisions; and
sending user input requests that request user input from the sender profile and the receiver profile to confirm agreement with the digital textual natural language contract.

17. One or more computer-readable memory having computer-executable instructions embodied thereon that, when executed by at least one processor, cause at least one processor to perform acts comprising:
maintaining a processing plan in a computer system according to one or more processing plan rules in the computer system, the processing plan comprising parameters for only one initial value transfer from a sender profile to a receiver profile to transfer an initial overall value amount;
initiating the initial value transfer in the computer system using the processing plan;
determining that the initial value transfer has failed;
in response to determining that the initial value transfer has failed, performing a processing plan modification routine, the processing plan modification routine comprising revising the processing plan to incorporate a fallback option allowed in the processing plan rules, the fallback option comprising multiple scheduled fallback value transfers that are each for amounts that are less than an amount of the initial value transfer, the fallback option changing the processing plan to transfer a fallback overall value amount that is greater than the initial overall value amount; and
initiating each of the multiple scheduled fallback value transfers.

18. The one or more computer-readable memory of claim 17, wherein the fallback option is a first fallback option, and wherein the processing plan modification routine comprises:
receiving a processing failure notification in the computer system, the processing failure notification indicating that the initial value transfer has failed;
generating a user input request, the user input request including an indication of a failure of the initial value transfer, and the user input request further including a request for user input to choose between multiple alternative fallback options to change the processing plan, the alternative fallback options being allowed in the processing plan rules;
responsive to the receiving of the processing failure notification, sending the user input request to the receiver profile via the computer system;
receiving from the receiver profile a computer-readable user input selection of the first fallback option of the alternative fallback options in the user input request; and
revising the processing plan to incorporate the first fallback option.

19. A computer-implemented method comprising the following acts:
in a value transfer computer system, presenting a user interface control that is designed to receive user input to indicate selection of a value transfer option from a plurality of available value transfer options comprising a first value transfer option and a second value transfer option, wherein the first value transfer option comprises processing plan value transfers being performed automatically via the value transfer computer system without requiring user input, wherein the second value transfer option comprises requiring user input confirming the processing plan value transfers prior to the processing plan value transfers being performed, and wherein the user interface control further comprises an indication of whether the first value transfer option or the second value transfer option is currently selected;
receiving user input directed at the user interface control indicating a selection of a selected value transfer option that is either the first value transfer option or the second value transfer option; and
in response to the receiving of the user input directed at the user interface control, changing the user interface control from a first display state to a second display state to indicate the selection of the selected value transfer option.

20. The computer-implemented method of claim 19, wherein the acts further comprise initiating value transfers according to a processing plan using the selected value transfer option.
